(19) United States
(12) Patent Application Publication
(10) Pub. No.: US 2021/0398218 A1
(43) Pub. Date: Dec. 23, 2021

(54) INFORMATION GENERATION SYSTEM, INFORMATION INDICATION SYSTEM, AND INFORMATION GENERATION PROGRAM

(71) Applicant: RISINGBULL.INC, Tokyo (JP)

(72) Inventor: Tetsuya Fujimura, Tokyo (JP)

(21) Appl. No.: 17/293,816

(22) PCT Filed: Nov. 15, 2019
(86) PCT No.: PCT/JP2019/044912

§ 371 Date: Sep. 3, 2021

(30) Foreign Application Priority Data
Nov. 15, 2018 (JP) 2018-214977
Feb. 21, 2019 (JP) 2019-029834

(51) Int. Cl. G06Q 40/06

(52) U.S. Cl. CPC G06Q 40/06; G09B 7/00

(57) ABSTRACT

An evaluation of trading data of investment products is provided. The server (3) that generates information on trading of investment products comprises the advice generation unit (321) that obtains trading data of investment products, obtains basic data from the obtained trading data, calculates evaluation indexes concerning trading gains and losses and unrealized gains and losses from the obtained basic data, obtains evaluation indexes concerning comprehensive gains and losses from the calculated evaluation indexes and generates information indicating the obtained evaluation indexes.

### TECHNICAL FIELD

The present invention relates to an information generation apparatus, an information presentation system, and an information generation program.

### BACKGROUND ART

Until now, systems that advise individual investors have been known. For example, Patent Literature 1 discloses financial investment management, portfolio management, and educational and analytical tools for members via an Internet site.

### CITATION LIST

### Patent Literature

[Patent Literature 1]

Published Japanese translations of PCT international publication for patent applications: “JP2003-531444A (Published on Oct. 21, 2003; internationally published on Oct. 25, 2001)”

### SUMMARY OF INVENTION

### Technical Problem

There are tools for evaluating and diagnosing static portfolios and stocks. However, at present, there are no tools that obtain investors' trading data and, based on the investors' trading data, evaluate and diagnose dynamically changing trading data to compare it with others and provide advice.

Although trading is a factor of investor disparities, there are no services to evaluate, diagnose, compare, and advise on it under present circumstances.

Formerly, as a complimentary service, sales representatives of securities companies used individual investors' trading data, comparing it with other customers' data, to grasp current situations and make proposals for improvement and otherwise. On the other hand, recently, as securities trading via the Internet spreads, functions such as proposals, diagnosis, and comparison with others by securities companies possessing trading data were lost, especially in online securities companies, seemingly making the above problems more noticeable.

The inability of comparison and grasping the current situations concerning whether appropriate trading has been made, as well as loss of advising functions, have widened investment disparities among individual investors and facilitated speculative trading. They do not move towards investing under present circumstances. Investors are confused because they cannot understand what trading they should make.

The object of one aspect of the present invention is to provide an evaluation of trading data of investment products.

### Solution to Problem

In order to solve these problems, an information generation apparatus with regard to one aspect of the present invention is an information generation apparatus that generates information on trading of investment products. The relevant apparatus comprises an information generation unit that obtains trading data of investment products, obtains basic data from the obtained trading data, calculates evaluation indexes concerning trading gains and losses and unrealized gains and losses from the obtained basic data, obtains evaluation indexes concerning comprehensive gains and losses from the calculated evaluation indexes and generates information indicating the obtained evaluation indexes.

This configuration allows the provision of an evaluation concerning trading data of investment products. Specifically, it is possible to provide an evaluation concerning comprehensive gains and losses, which are the sum of trading gains and losses and unrealized gains and losses.

Additionally, within the information generation apparatus with regard to one aspect of the present invention, as evaluation indexes concerning the unrealized gains and losses, the information generation unit may calculate evaluation indexes including trading gains and losses from the basic data and generate information indicating the calculated evaluation indexes.

This configuration allows the provision of an evaluation concerning comprehensive gains and losses, taking into account trading gains and losses. Specifically, it is possible to provide a simple evaluation.

Additionally, within the information generation apparatus with regard to one aspect of the present invention, as evaluation indexes concerning the unrealized gains and losses, the information generation unit may calculate evaluation indexes including trading gains and losses as well as winning gain rate or losing loss rate from the basic data and generate information indicating the calculated evaluation indexes.

This configuration allows the provision of an evaluation concerning comprehensive gains and losses, taking into account trading gains and losses and winning gain rate or losing loss rate.

Additionally, within the information generation apparatus with regard to one aspect of the present invention, as evaluation indexes concerning the unrealized gains and losses, the information generation unit may calculate evaluation indexes including trading gains and losses as well as winning gain rate or losing loss rate and cash ratio from the basic data and generate information indicating the calculated evaluation indexes.

This configuration allows the provision of an evaluation concerning comprehensive gains and losses, taking into account trading gains and losses, winning gain rate or losing loss rate, and cash ratio.

Additionally, within the information generation apparatus with regard to one aspect of the present invention, as evaluation indexes concerning the unrealized gains and losses, the information generation unit may calculate evaluation indexes including trading gains and losses as well as winning gain rate or losing loss rate, cash ratio, and purchase winning weight from the basic data and generate information indicating the calculated evaluation indexes.

This configuration allows the provision of an evaluation concerning comprehensive gains and losses, taking into account trading gains and losses, winning gain rate or losing loss rate, cash ratio, and purchase winning weight.

Additionally, within the information generation apparatus with regard to one aspect of the present invention, as evaluation indexes concerning the unrealized gains and losses, the information generation unit may calculate evaluation indexes including trading gains and losses as well as winning gain rate or losing loss rate, cash ratio, purchase winning weight, and principal from the basic data and generate information indicating the calculated evaluation indexes.

This configuration allows the provision of an evaluation concerning comprehensive gains and losses, taking into account trading gains and losses, winning gain rate or losing loss rate, cash ratio, purchase winning weight, and principal.

Additionally, within the information generation apparatus with regard to one aspect of the present invention, the information generation unit may preferentially generate information indicating lower-evaluated indexes out of a plurality of evaluation indexes concerning the unrealized gains and losses.

This configuration preferentially generates information indicating lower-evaluated indexes. Therefore, users can focus on the indexes with big problems to efficiently improve comprehensive gains and losses.

Additionally, within the information generation apparatus with regard to one aspect of the present invention, the information generation unit may generate information indicating diagnosis, ranking, comparison, or advice, using evaluation indexes concerning the comprehensive gains and losses or the unrealized gains and losses.

This configuration allows the provision of meaningful information to users, using evaluation indexes concerning comprehensive gains and losses or unrealized gains and losses.

Additionally, within the information generation apparatus with regard to one aspect of the present invention, the information generation unit may calculate purchase prices, product valuation amount, and benchmark valuation amount from the basic data, then compare the purchase prices, the product valuation amount, and the benchmark valuation amount to generate information indicating a diagnosis or advice concerning asset status according to the comparison result.

This configuration allows the provision of the diagnosis or advice concerning asset status, taking into account the rise and fall of the valuation amounts of investment products as well as the comparison of the valuation amounts between investment products and benchmarks.

Additionally, within the information generation apparatus with regard to one aspect of the present invention, the information generation unit may obtain yet-to-reversed trading data from the trading data, then classify the yet-to-reversed trading data into patterns according to current prices, purchase prices, rise/fall rate of investment products held as well as the rise/fall rate of benchmarks, then calculate a purchase price or product valuation amount for each of such patterns from the yet-to-reversed trading data to generate information indicating a diagnosis or advice concerning asset status according to the ratio of the purchase price or product valuation amount for each of such patterns.

This configuration allows the provision of the diagnosis or advice concerning asset status, taking into account the amount ratio for each relevant pattern according to the current prices, purchase prices, rise/fall rate of held products, and the rise/fall rate of benchmarks.

The information generation apparatus with regard to one aspect of the present invention is an information generation apparatus that generates information on virtual trading of investment products in the past. It comprises an information generation unit that obtains a start date of the virtual trading and initial conditions, including those of assumed holding status of the investment products and cash at such start date. The unit then generates using such initial conditions at least two questioning screens consecutively, that include dates of events occurring after the start date as well as questions and options concerning trading of the investment products.

This configuration allows users to select one of the options provided in a question concerning the trading of investment products in the past and experience the trading of investment products in the past virtually.

Additionally, within the information generation apparatus with regard to one aspect of the present invention, the questioning screens may further contain the events.

This configuration allows the provision of a basis for judgment to users concerning trading of investment products because users can check past events.

Additionally, within the information generation apparatus with regard to one aspect of the present invention, the questioning screens may further contain valuation amounts of held assets, including the investment products and cash at dates of the events.

This configuration allows the provision of an evaluation concerning virtual trading data of investment products in the past.

Additionally, within the information generation apparatus with regard to one aspect of the present invention, the information generation unit may reckon a valuation amount of each investment product at 100 as the base at the first date of the events, then calculate an index of the valuation amount of each investment product at the second and later dates of the events based on said 100.

This configuration uniforms valuation amounts of investment products into 100 as the base at the first date of the events, then calculates an index of the valuation amount of each investment product at the second and later dates of the events based on said 100. Therefore, users can intuitively grasp the transition status of the valuation amount of each investment product and its comparison result.

Additionally, the information generation system with regard to one aspect of the present invention is an information presentation system, comprising the information generation apparatus and a terminal apparatus. The terminal apparatus presents information generated by the information generation unit to users.

This configuration allows the provision of an evaluation concerning trading data of investment products.

### Advantageous Effects of Invention

One aspect of the present invention allows the provision of an evaluation concerning trading data of investment products.

### BRIEF DESCRIPTION OF DRAWINGS

FIG. 1 is a diagram showing the hardware configuration of the advice presentation system with regard to the embodiment 1 of the present invention.

FIG. 2 is a block diagram showing the configuration of the terminal and the server with regard to the embodiment 1 of the present invention.

FIG. 3 is a diagram showing the outline of processing of the advice presentation system with regard to the embodiment 1 of the present invention.

FIG. 4(a) is a diagram showing an example of trading data of investment products with regard to the embodiment 1 of the present invention.

FIG. 4(b) is a diagram showing an example of evaluation indexes of trading data with regard to the embodiment 1 of the present invention.

FIG. 5 is a flowchart showing the diagnostic processing based on the principal turnover period with regard to the embodiment 1 of the present invention.

FIG. 6 is a flowchart showing the diagnostic processing based on the winning gain rate with regard to the embodiment 1 of the present invention.

FIG. 7 is a flowchart showing the diagnostic processing based on the losing loss rate with regard to the embodiment 1 of the present invention.

FIG. 8 is a flowchart showing the diagnostic processing based on the trading gains and losses with regard to the embodiment 1 of the present invention.

FIG. 9 is a flowchart showing the classification processing of trading patterns with regard to the embodiment 1 of the present invention.

FIG. 10 is a flowchart showing the diagnostic processing based on the rise/fall rate of held stocks with regard to the embodiment 1 of the present invention.

FIG. 11 is a flowchart showing the ranking processing based on the principal increase/decrease rate with regard to the embodiment 1 of the present invention.

FIG. 12 is a flowchart showing the processing of the comprehensive gain-and-loss analysis with regard to the embodiment 1 of the present invention.

FIG. 13 is a diagram showing an example of evaluation numerical values of comprehensive gains and losses, trading gains and losses, and unrealized gains and losses according to the levels of detail with regard to the embodiment 1 of the present invention.

FIG. 14 is a diagram showing an example of evaluation indexes of held products with regard to the embodiment 1 of the present invention.

FIG. 15 is a diagram showing an example of patterns of held products with regard to the embodiment 1 of the present invention.

FIG. 16 is a diagram showing an example of the initial screen of the stock investment simulation with regard to the embodiment 2 of the present invention.

FIG. 17 is a diagram showing an example of the questioning screen of the stock investment simulation with regard to the embodiment 2 of the present invention.

FIG. 18 is a diagram showing an example of the transition of a stock price in the stock investment simulation with regard to the embodiment 2 of the present invention.

FIG. 19 is a diagram showing an example of the transition of the valuation amount for each fork of each question in the stock investment simulation with regard to the embodiment 2 of the present invention.

### DESCRIPTION OF EMBODIMENTS cl Embodiment 1

Hereinafter, Embodiment 1 of the present invention will be described in detail. The contents of diagnostic results and advice and the like shown below are mere examples and do not limit the present invention.

(Advice Presentation System 1)

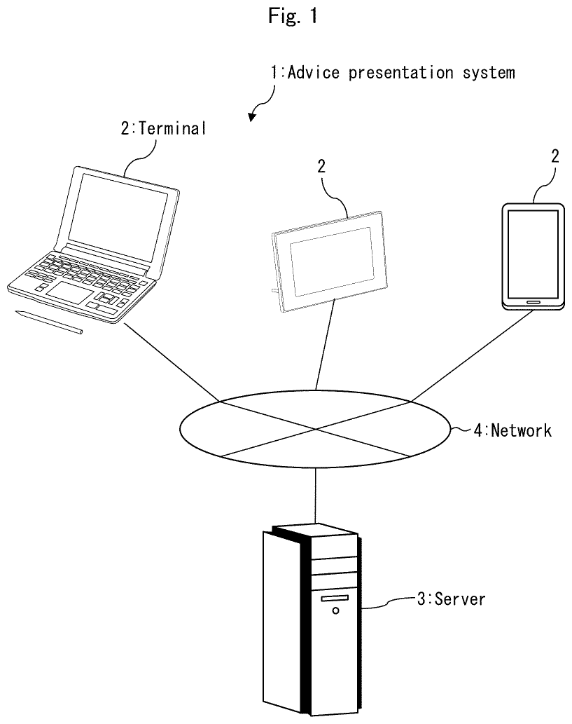

The advice presentation system (information presentation system) 1 with regard to the present embodiment will be described referencing the drawings. FIG. 1 is a diagram showing the hardware configuration of the advice presentation system 1 with regard to the present embodiment. As shown in FIG. 1, the advice presentation system 1 includes a terminal (terminal apparatus) 2 and a server (information generation apparatus) 3. The terminal 2 and the server 3 are configured to be capable of communicating with each other via the network 4.

The terminal 2 obtains trading data through a user operation, reading from recording media, and otherwise, to display advice according to the trading data. Examples of terminal 2 include a PC, a tablet terminal, a smartphone, and the like. The server 3 generates advice on trading of investment products. The network 4 is a network including the Internet. Investment products include stocks (including Japanese stocks and overseas stocks), investment trusts, exchange-traded funds (ETFs), foreign exchange margin trading (FX), and the like.

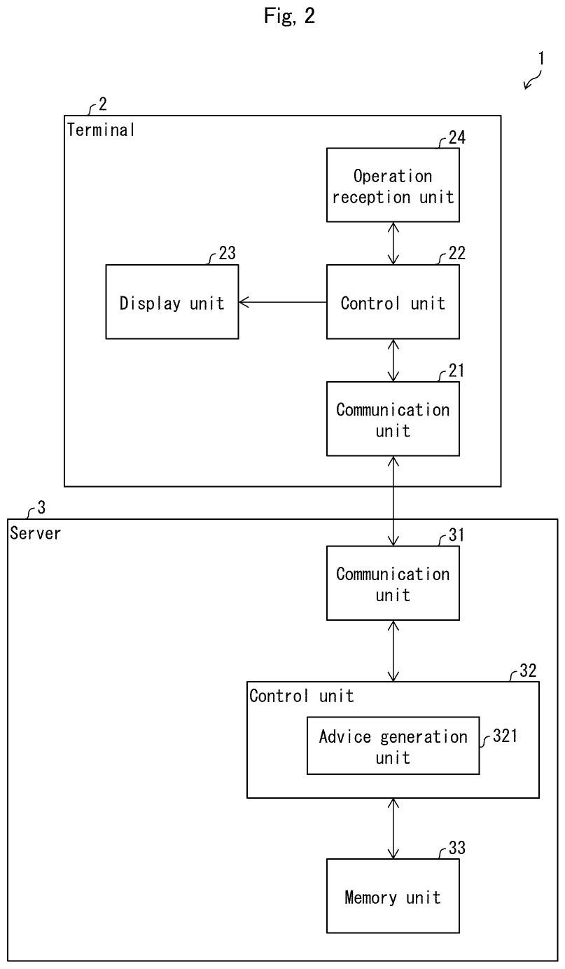

FIG. 2 is a block diagram showing the configuration of the terminal 2 and the server 3 with regard to the present embodiment.

(Terminal 2)

As shown in FIG. 2, the terminal 2 comprises a communication unit 21, a control unit 22, a display unit 23, and an operation receiving unit 24. The communication unit 21 is a part that communicates with the server 3. The control unit 22 controls the entire terminal 2 and comprises, for example, one or more processors or the like. The display unit 23 displays data according to instructions from the control unit 22 and comprises, for example, a liquid crystal display or the like. The operation receiving unit 24 receives a user operation. Examples of operation receiving unit 24 include a keyboard, a mouse, a touch panel, and the like.

(Server 3)

As shown in FIG. 2, the server 3 comprises a communication unit 31, a control unit 32, and a storage unit 33. The communication unit 31 is a part that communicates with the terminal 2. The control unit 32 controls the entire server 3 and comprises, for example, one or more processors or the like. The storage unit 33 stores data according to instructions from the control unit 22. Examples of storage unit 33 include a hard disk drive, a flash memory, and the like.

The control unit 32 comprises an advice generation unit (information generation unit) 321. The advice generation unit 321 obtains trading data of investment products, obtains basic data from the obtained trading data, calculates evaluation indexes referencing the obtained basic data, then generates information indicating the calculated evaluation indexes. Next, the advice generation unit 321 makes a diagnosis referencing the evaluation indexes to generate information indicating the result of such diagnosis. Further, the advice generation unit 321 generates information indicating advice according to the diagnostic result.

The evaluation mentioned here refers to calculating and evaluating each index from the trading data, and the diagnosis refers to diagnosing what sort of trading has been conducted based on those indexes, and the advice refers to giving advice based on evaluation results and diagnostic results. However, the process comprising evaluation, diagnosis, and advice is not mandatory, and they may be provided separately.

Additionally, the advice generation unit 321 may obtain total gains and losses from the trading data, then calculate evaluation indexes referencing the total gains and losses, then generate information indicating the calculated evaluation indexes. Next, the advice generation unit 321 may obtain total trading gains and losses and total unrealized gains and losses from the trading data, then calculate evaluation indexes referencing the total trading gains and losses and total unrealized gains and losses, then generate information indicating the calculated evaluation indexes. Further, the advice generation unit 321 may obtain total winning gains, total losing losses, and total unrealized gains and losses from the trading data, then calculate evaluation indexes referencing the total winning gains, the total losing losses, and the total unrealized gains and losses, then generate information indicating the calculated evaluation indexes.

Additionally, the advice generation unit 321 may obtain already-traded data from the trading data, then classify the already-traded data into patterns according to the purchase prices, selling prices, and market prices after the sale, then calculate total gains and losses for each relevant pattern, then calculate evaluation indexes referencing the total gains and losses for each pattern, then generate information indicating the calculated evaluation indexes. The market prices after the sale indicate the market prices after a certain period of time has elapsed since the sale, including, for example, the market price at the time three months after the sale, the market price at the time a year after the sale, the market price at the time of valuation, and the like. The terminal 2 presents the information generated by the advice generation unit 321 to users.

Additionally, the advice generation unit 321 may calculate evaluation indexes referencing the trading data, then make a comparison of and rank the investor referencing the calculated evaluation indexes, then generate as evaluation indexes information indicating the comparison result and ranking of such investor. The comparison mentioned here refers to comparing the evaluation indexes of the relevant investor with the evaluation indexes of other investors, the average values of investors' evaluation indexes, and the like.

### (Processing Outline of Advice Presentation System 1)

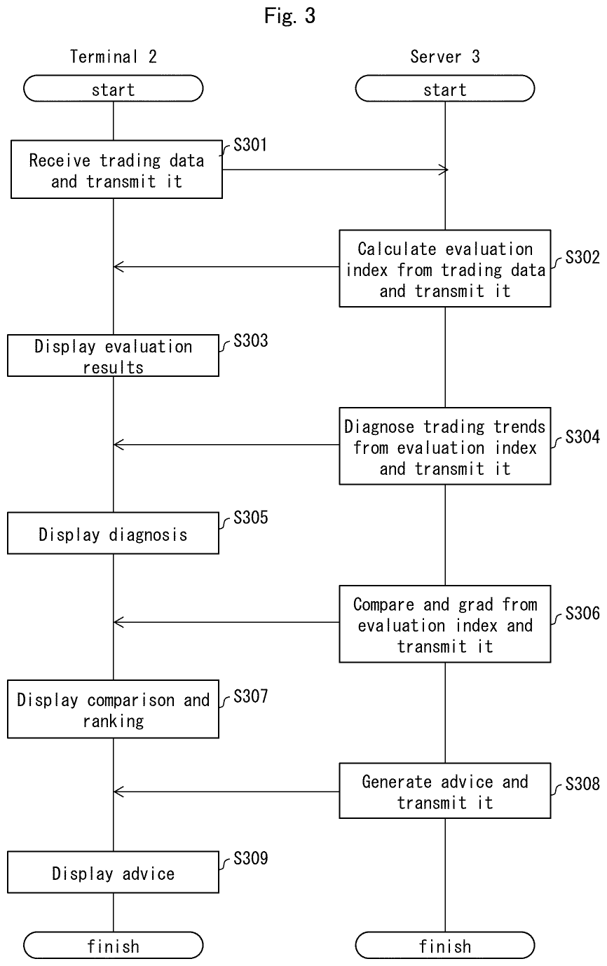

FIG. 3 is a diagram showing the outline of processing of the advice presentation system 1 with regard to the present embodiment. The outline of processing of the advice presentation system 1 will be described referencing FIG. 3.

(Step S301)

In the terminal 2, the control unit 22 obtains the trading data of investment products from the operation receiving unit 24 and the like, then transmits such trading data to the server 3 via the communication unit 21. Details of the trading data will be described separately.

(Step S302)

In the server 3, the control unit 32 receives the trading data from the terminal 2 via the communication unit 31. The advice generation unit 321 calculates evaluation indexes from the trading data. The control unit 32 transmits the calculated evaluation indexes via the communication unit 31 to the terminal 2 as an evaluation result. Details of the evaluation indexes will be described separately.

(Step S303)

In the terminal 2, the control unit 22 receives the evaluation result from the server 3 via the communication unit 21 and lets the display unit 23 display such evaluation result.

(Step S304)

In the server 3, the advice generation unit 321 diagnoses the user's trading tendency from the evaluation indexes calculated in step S302. The control unit 32 transmits the diagnosed trading tendency via the communication unit 31 to the terminal 2 as a diagnostic result.

(Step S305)

In the terminal 2, the control unit 22 receives the diagnostic result from the server 3 via the communication unit 21 and lets the display unit 23 display such diagnostic result.

(Step S306)

In the server 3, the advice generation unit 321 makes a comparison of and ranks the investor using the evaluation indexes calculated in step S302. The control unit 32 transmits comparison data and ranking data of the relevant investor via the communication unit 31 to the terminal 2.

(Step S307)

In the terminal 2, the control unit 22 receives the comparison data and ranking data of the investor from the server 3 via the communication unit 21 and lets the display unit 23 display the comparison and ranking results of such investor.

(Step S308)

In the server 3, the advice generation unit 321 generates advice on trading of investment products by referencing trading data of investment products, evaluation indexes, the user's trading tendency, comparison data among investors, ranking data, and the like. The control unit 32 transmits the generated advice via the communication unit 31 to the terminal 2.

(Step S309)

In the terminal 2, the control unit 22 receives advice on trading of investment products from the server 3 via the communication unit 21 and lets the display unit 23 display such advice.

In the server 3, the calculation of evaluation indexes, referencing trading data to be evaluated, and storage of them into a DB and the creation and storage into the DB of diagnostic data are executed, for example, by batch processing. The DB is configured, for example, in the storage unit 33 of the server 3.

(Example of Trading Data)

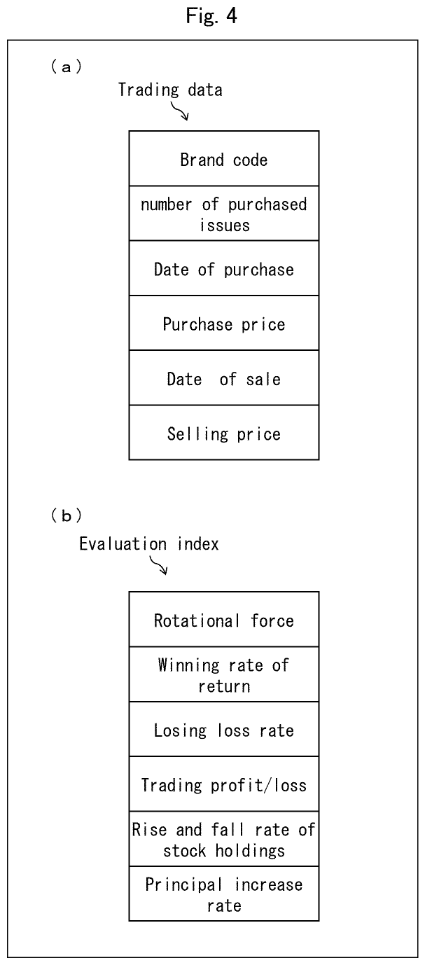

FIG. 4(a) is a diagram showing an example of trading data of investment products with regard to the present embodiment. Hereinafter, stocks are used as an example of investment products for the description. As shown in FIG. 4(a), the trading data includes stock code, the number of shares purchased, a purchase date, and purchase price. The already-sold data further includes a sale date and selling price. Additionally, in the case starting with the sale (for example, margin trading or the like), the trading data includes stock code, the number of shares sold, a sale date, and selling price. The already-covered data further includes a short-covering date and short-covering price.

The stock code is a code that specifies the stocks to be traded. The number of shares purchased is the number of shares purchased by the user. The purchase date is the date when the user purchases the relevant stocks. The purchase price is the stock price when the user purchases the relevant stocks. The sale date is the date when the user sells the relevant stocks. The selling price is the stock price when the user sells the relevant stocks.

(Example of Evaluation Indexex)

FIG. 4(b) is a diagram showing an example of evaluation indexes of trading data with regard to the present embodiment. Hereinafter, stocks are used as an example of investment products for the description. As shown in FIG. 4(b), the evaluation indexes are calculated based on a plurality of evaluation axes. Examples of evaluation indexes include turnover force, winning gain rate, losing loss rate, trading gains and losses, rise/fall rate of held stocks, principal increase/decrease rate, and the like.

The basic numerical values described later refer to the numerical values obtained from trading data such as principal, elapsed period, the number of trades, and the like. The evaluation indexes refer to indexes calculated from those basic numerical values and the like. The evaluation axes refer to a perspective for evaluating trading data and comprise one or more evaluation indexes.

An example of an evaluation axis is described below. The turnover force is an example of an evaluation axis that indicates how fast the user is turning over the principal, or to put it another way, how often the user is replacing the stocks. The indexes related to turnover force include average holding period, principal turnovers, principal turnover period, average trading period difference, and the like. The indexes of turnover force refer to indexes for evaluating, comparing, diagnosing, and giving advice on how often the user is trading.

The average holding period refers to the average value of the holding period of trading stocks. The principal turnovers refer to an index indicating the number of turnovers of the principal in a prescribed period. It is calculated as “trading prices for a prescribed period÷principal.” The principal turnover period refers to the average value of time needed for the principal to turn over once. It is calculated as “number of days in a prescribed period÷principal turnovers.” The average trading period difference is calculated as “the average trading period in winning−the average trading period in losing.”

The winning gain rate is an example of an evaluation axis that indicates the gain rate in winning. Based on the winning data obtained by classifying the already-traded data, it is calculated as “gain amount per win÷trading price per win.” The gain amount per win is calculated as “total gain amount÷number of wins.” The trading price per win is calculated as “total trading prices in winning÷number of wins.” The winning gain rate is an example of an evaluation axis for evaluating, comparing, and diagnosing winning patterns and further giving advice on how to win.

The losing loss rate is an example of an evaluation axis that indicates the loss rate in losing. Based on the losing data obtained by classifying the already-traded data, it is calculated as “loss amount per loss÷trading price per loss.” The loss amount per loss is calculated as “total loss amount÷number of losses.” The trading price per loss is calculated as “total trading prices in losing÷number of losses.” The losing loss rate is an example of an evaluation axis for evaluating, comparing, and diagnosing losing patterns and giving advice on how to shrink losses from the current state.

The trading gains and losses are an example of an evaluation axis that indicates the entire gains and losses of already-traded products in a prescribed period. It is calculated as follows:

“Trading gains and losses=winning percentage×trading prices in winning×winning gain rate/number of wins×principal×(elapsed days÷turnover period in days of principal)/trading price per trade+(1−winning percentage)×trading prices in losing×losing loss rate/number of losses×principal×(elapsed days÷turnover period in days of principal)/trading price per trade.”

Trading gains and losses are an evaluation axis of already-traded data, including both wins and losses. It is an example of an axis that evaluates where problems are and what are good in trading. Trading gains and losses are an example of an evaluation axis for identifying, evaluating, comparing, and diagnosing problems and giving advice on how to improve trading further. The total gains and losses are calculated as follows: “Comprehensive gains and losses=trading gains and losses+unrealized gains and losses.”

The rise/fall rate of held stocks is an example of an evaluation axis calculated as “gain-and-loss amount of entire held stocks÷holding amount.” The gain-and-loss amount of entire held stocks refers to the total amount of “(current price−purchase price)×number of shares purchased.” The holding amount refers to the total amount of “purchase price×number of shares purchased” of the held stocks. The rise/fall rate of held stocks is an example of an evaluation axis for evaluating, comparing, diagnosing, and analyzing data for those purchased and held and not yet sold. It is also an example of an evaluation axis for giving advice on the state of continuing to hold the stocks after the purchase without selling them out.

The principal increase/decrease rate is calculated as “comprehensive gains and losses÷principal” as well as “(trading gains and losses+gain-and-loss amount of entire held stocks)÷principal÷elapsed period (in years).” The principal increase/decrease rate is an example of an evaluation axis for evaluating, comparing, diagnosing, and giving advice through comprehensive evaluation covering the trading status and the holding status.

(Details of Diagnostic Processing)

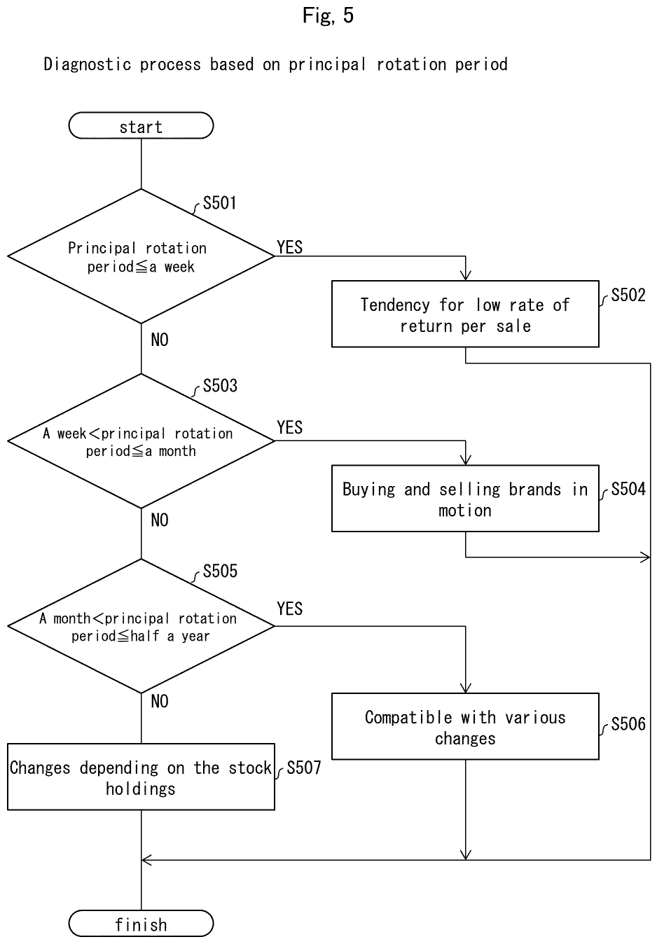

FIG. 5 to FIG. 11 are flowcharts showing the diagnostic processing of the advice generation unit 321 in the server 3 with regard to the present embodiment. FIG. 5 shows the diagnostic processing based on the principal turnover period.

(Step S501)

The advice generation unit 321 determines whether the principal turnover period does not exceed one week. When the principal turnover period is equal to or shorter than one week (YES in step S501), the advice generation unit 321 executes the processing of step S502. When the principal turnover period is longer than one week (NO in step S501), the advice generation unit 321 executes the processing of step S503.

(Step S502)

The advice generation unit 321 generates a diagnostic result regarding the user's trading tendency, including the followings:
Information on the user's trading tendency
Information on the reasons for the user's trading tendency
Information on the social aspect of the user's trading tendency
Information to improve the user's trading tendency
(The same shall apply to steps S504, S506, and S507).

Regarding the user's trading tendency, the advice generation unit 321 performs evaluation, comparison, diagnosis, and advice concerning the evaluation axis of turnover force, for example, as follows. Comparison and diagnosis are performed: “Your frequent trading is akin to day trading and scalping. Since the principal turns over once within a week, the stocks are replaced frequently. There is a tendency to focus on technicals and winning percentage, so the gain rate per trade usually tends to be low for both wins and losses. It is important to follow other indexes such as the winning gain rate. As an improvement proposal, we recommend that if the average trading period difference is below or close to zero, you should extend the average trading period in winning.”

(Step S503)

The advice generation unit 321 determines whether the principal turnover period exceeds one week and does not exceed one month. When the principal turnover period is longer than one week and equal to or shorter than one month (YES in step S503), the advice generation unit 321 executes the processing of step S504. When the principal turnover period is longer than one month (NO in step S503), the advice generation unit 321 executes the processing of step S505.

(Step S504)

Regarding the user's trading tendency, the advice generation unit 321 performs comparison and diagnosis, for example, as follows. “Since the principal turns over once within a month, the stocks are replaced more than ten times a year. Your trading falls under the swing-trading category. This category is further fragmented due to the broad concept according to the levels of average trading period or trading price per trade. However, in general, technicals being focused on and incentive-backed stocks dominating, the style is to trade sharply fluctuating stocks. In order to increase assets with this type, the winning percentage and the difference between the winning gain rate and losing loss rate are essential in the first place. See the evaluation axes such as winning gain rate, losing loss rate, and comprehensive gain rate.”

(Step S505)

The advice generation unit 321 determines whether the principal turnover period exceeds one month and does not exceed six months. When the principal turnover period is longer than one week and equal to or shorter than one month (YES in step S505), the advice generation unit 321 executes the processing of step S506. When the principal turnover period is longer than six months (NO in step S505), the advice generation unit 321 executes the processing of step S507.

(Step S506)

Regarding the user's trading tendency, the advice generation unit 321 performs comparison and diagnosis, for example, as follows. “Your trading frequency is such that the stocks are replaced several times a year. If ‘the average trading period in winning−the average trading period in losing’ is much higher than zero, you are likely to have succeeded in asset building. Of course, it depends on the balance with other evaluation axes; however, regarding trading frequency, you can trade with pressure-free frequency and at a level capable of responding to various changes. You can respond to not only technicals and fundamentals but also sudden changes in market trends and world situations. The difference between the winning gain rate and the losing loss rate is the most vital point for this trading tendency. The larger the difference, the better the operation.”

(Step S507)

Regarding the user's trading tendency, the advice generation unit 321 performs comparison and diagnosis, for example, as follows. “When both the average holding period and the principal turnover period exceed six months, the trading tendency changes greatly depending on the status of the held stocks. This is because those cases are often seen where various held stocks have unrealized losses. These are the cases incapable of so-called loss cut resulting in holding mainly poor-performance stocks, that is, the state of being left in mothballs. In the past, banks had many bad loans and slipped down into a vicious circle; now, in these cases, the bad loans (bad assets) of the household economy are the existence of stocks left in mothballs. These situations are likely to be caused by an excessively low trading frequency, and many cases fall under this trading tendency. Combining it with other evaluation axes will determine whether the relevant situation falls under the category of these cases. The crucial evaluation axes are those of the diagnosis of trading gains and losses as well as the analysis of holding status. As trading advice, if the above applies, you should dispose of the held stocks even at a gradual pace and make the trading more active.

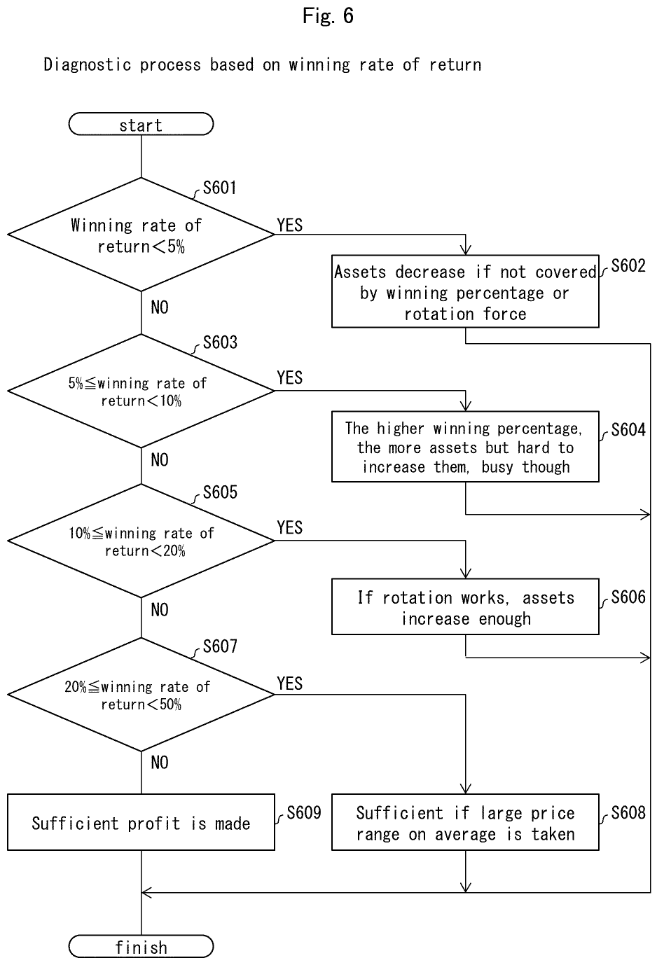

FIG. 6 is a flowchart showing the diagnostic processing based on the winning gain rate of the advice generation unit 321 in the server 3 with regard to the present embodiment.

(Step S601)

The advice generation unit 321 determines whether the winning gain rate is less than five percent. When the winning gain rate is less than five percent (YES in step S601), the advice generation unit 321 executes the processing of step S602. When the winning gain rate is not less than five percent, that is to say, is equal to or more than five percent (NO in step S601), the advice generation unit 321 executes the processing of step S603.

(Step S602)

The advice generation unit 321 generates a diagnostic result regarding the user's trading tendency, including the followings:
Information on the user's trading tendency
Information on the reasons for the user's trading tendency
Information on the social aspect of the user's trading tendency
Information to improve the user's trading tendency
(The same shall apply to steps S604, S606, S608, and S609).

Regarding the user's trading tendency, the advice generation unit 321 performs comparison and diagnosis, for example, as follows. “Your winning gain rate is too low. Therefore, unless covered by winning percentage or turnover force, the assets will decrease. If the winning gain rate is lower than the absolute value of the losing loss rate, we can say that there is even more room for improvement. If the average holding period in winning is shorter than one week, it may be a little too early. The selection of stocks to purchase might be wrong in the first place. See the indexes of trading analysis for patterns.”

(Step S603)

The advice generation unit 321 determines whether the winning gain rate is equal to or more than five percent and less than ten percent. When the winning gain rate is equal to or more than five percent and less than ten percent (YES in step S603), the advice generation unit 321 executes the processing of step S604. When the winning gain rate is not less than ten percent, that is to say, is equal to or more than ten percent (NO in step S603), the advice generation unit 321 executes the processing of step S605.

(Step S604)

Regarding the user's trading tendency, the advice generation unit 321 performs comparison and diagnosis, for example, as follows. “The turnover rate is high, and the losing loss rate is controlled. Therefore, if the winning percentage is high, it can lead to trading that increases the assets. However, if the above conditions are not met, it tends to lead to a situation where your assets do not increase, considering busy working. Your trading technique may be good, but your selection of stocks may have flaws. Although it is strictly needed to combine it with other evaluation axes, if you have difficulty in securing an extensive price spread, you need to recheck whether the selection of stocks is correct in the first place. It would help if you rechecked the correctness of your stock selection in the first place through the trading gains and losses and the trading pattern analysis.”

(Step S605)

The advice generation unit 321 determines whether the winning gain rate is equal to or more than ten percent and less than twenty percent. When the winning gain rate is equal to or more than ten percent and less than twenty percent (YES in step S605), the advice generation unit 321 executes the processing of step S606. When the winning gain rate is not less than twenty percent, that is to say, is equal to or more than twenty percent (NO in step S605), the advice generation unit 321 executes the processing of step S607.

(Step S606)

Regarding the user's trading tendency, the advice generation unit 321 performs comparison and diagnosis, for example, as follows. “Your winning gain rate is high and excellent. The winning percentage is high, and the losing loss rate is controlled. If the turnover is also effective, it leads to a rhythm where the assets increase sufficiently. If possible, by raising the winning gain rate to the next level, the pace of asset increase will further increase. Can you elongate the average holding period in winning? You should find out how to boost further the increasing pace by analyzing winning stocks through the trading gains and losses and the trading pattern analysis. By leveraging strategic stocks, the likeliness of securing a more extensive price spread will increase.”

(Step S607)

The advice generation unit 321 determines whether the winning gain rate is equal to or more than twenty percent and less than fifty percent. When the winning gain rate is equal to or more than twenty percent and less than fifty percent (YES in step S607), the advice generation unit 321 executes the processing of step S608. When the winning gain rate is not less than fifty percent, that is to say, is equal to or more than fifty percent (NO in step S607), the advice generation unit 321 executes the processing of step S607.

(Step S608)

Regarding the user's trading tendency, the advice generation unit 321 performs comparison and diagnosis, for example, as follows. “It can be said sufficient when you secure such an extensive price spread on average. You need to pay attention to how effective the turnover is, the losing loss rate, the winning percentage, and whether the held stocks have losses. If flaws are found in the above points, there is still room for improvement. The turnover force is of particular importance. If the turnover force is too low, it indicates the possibility that there is intrinsically much more room for the asset-growth pace to increase.”

(Step S609)

Regarding the user's trading tendency, the advice generation unit 321 performs comparison and diagnosis, for example, as follows. “As long as determined from these figures only, you have achieved sufficient gains. If other figures related to the following points are also excellent, it indicates you have attained a rhythm where the assets increase by leaps. Having no problems with such points as (1) how effective the turnover is; (2) what is the losing loss rate; (3) what is the winning percentage; and (4) whether the held stocks have losses; indicates it is ideal. If there is a problem with any of the above four points, you should improve it as a first step. For example, if you hold various stocks that have extensive losses, it indicates that you have taken profits prudently but could not cut losses and have left them. Therefore, it is crucial to learn how to deal with lost cases as soon as possible. Take profits slowly, cut losses fast.”

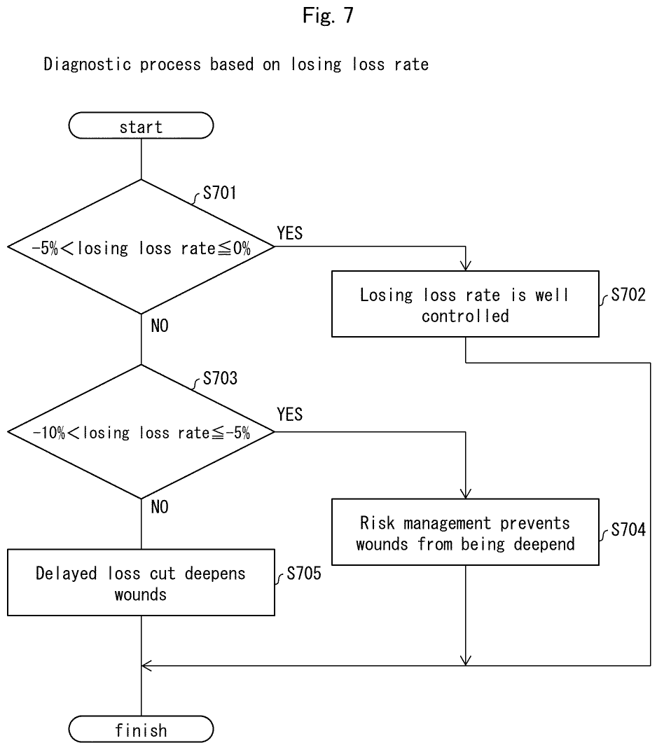

FIG. 7 is a flowchart showing the diagnostic processing based on the losing loss rate of the advice generation unit 321 in the server 3 with regard to the present embodiment.

(Step S701)

The advice generation unit 321 determines whether the losing loss rate is more than minus five percent and equal to or less than zero percent. When the losing loss rate is more than minus five percent and equal to or less than zero percent (YES in step S701), the advice generation unit 321 executes the processing of step S702. When the losing loss rate is not more than minus five percent, that is to say, is equal to or less than minus five percent (NO in step S701), the advice generation unit 321 executes the processing of step S703.

(Step S702)

The advice generation unit 321 generates a diagnostic result regarding the user's trading tendency, including the followings:
Information on the user's trading tendency
Information on the reasons for the user's trading tendency
Information on the social aspect of the user's trading tendency
Information to improve the user's trading tendency
(The same shall apply to steps S704 and S705).

Regarding the user's trading tendency, the advice generation unit 321 performs comparison and diagnosis, for example, as follows. “The loss rate in losing is sufficiently controlled, and the performance is excellent. The winning percentage and the winning gain rate are sufficient; if there are no problems with the holding status, it can be said as a rhythm where the assets increase. However, the most vital point is how large the ‘winning gain rate+losing loss rate’ is. When the winning gain rate is five percent and the losing loss rate is minus five percent, the difference is zero. If the winning percentage stands at fifty percent, the trading does not generate gains nor losses. It ends in busy working in trading without any results. On the other hand, when the winning gain rate is thirty percent and the losing loss rate is minus five percent, the difference is sufficiently large as twenty-five percent. In this case, even if the winning percentage stands at fifty percent, the funds increase sufficiently. Although combining it with other indexes is needed, it is possible to say that the losing loss rate is excellent.”

(Step S703)

The advice generation unit 321 determines whether the losing loss rate is more than minus ten percent and equal to or less than minus five percent. When the losing loss rate is more than minus ten percent and equal to or less than minus five percent (YES in step S703), the advice generation unit 321 executes the processing of step S704. When the losing loss rate is not more than minus ten percent, that is to say, is equal to or less than minus ten percent (NO in step S703), the advice generation unit 321 executes the processing of step S705.

(Step S704)

Regarding the user's trading tendency, the advice generation unit 321 performs comparison and diagnosis, for example, as follows. “The losing loss rate is sufficiently controlled, and risk management that avoids deepening the wounds is prudently exercised. Unless any of your held stocks have been deeply wounded, loss cut works quite effectively. In this case, it is of most importance that the winning gain rate exceeds the losing loss rate significantly. If both indexes are at similar levels, the result depends on the winning percentage. In the cases where your assets do not increase considering busy working, you need to take profits slowly and cut losses fast. You need to check whether the initial selection of stocks is correct through the trading pattern analysis.”

(Step S705)

Regarding the user's trading tendency, the advice generation unit 321 performs comparison and diagnosis, for example, as follows. “Loss cut tends to be delayed, resulting in deepening the wounds. In order to transition to a rhythm where the assets increase, it is crucial to cut losses earlier without hesitation to control the losses. The reason is as follows. An asset of one million yen which suffers a twenty-percent loss makes its value eight hundred thousand yen. Next, to have the asset get back to the initial one million yen, you have to generate gains of twenty-five percent. When gains are generated, it leads to a virtuous circle where gains breed gains. Conversely, when extensive losses are generated, resulting in fund reduction, the principal will be reduced. You have to manage with fewer and fewer funds, making it quite challenging to start recovering. If possible, you should be able to control the losing loss rate under ten percent.”

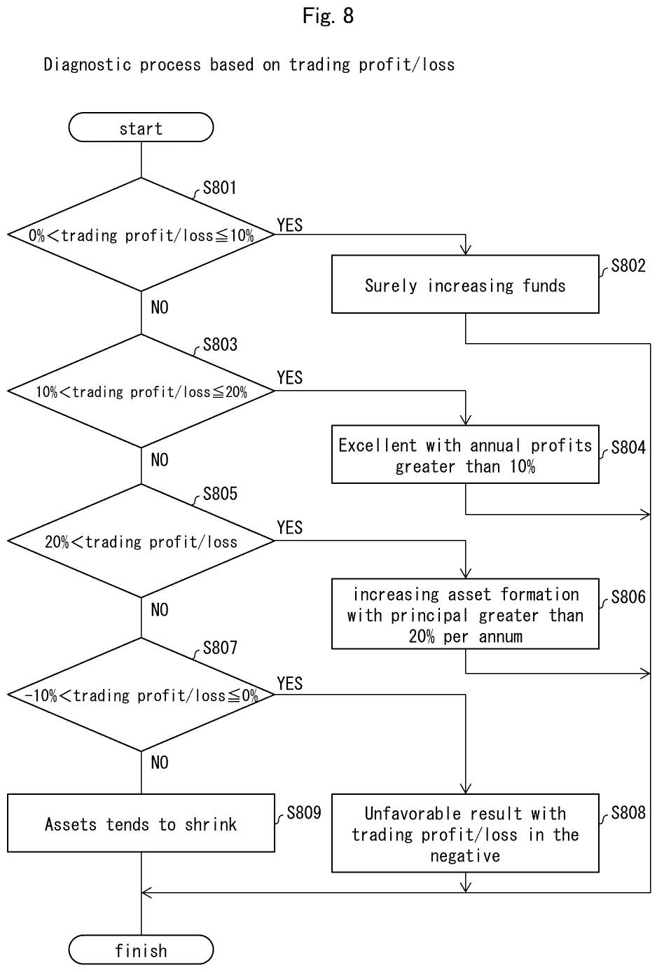

FIG. 8 is a flowchart showing the diagnostic processing based on the trading gains and losses of the advice generation unit 321 in the server 3 with regard to the present embodiment.

(Step S801)

The advice generation unit 321 determines whether the trading gains and losses are more than zero percent and equal to or less than ten percent. When the trading gains and losses are more than zero percent and equal to or less than ten percent (YES in step S801), the advice generation unit 321 executes the processing of step S802. When the trading gains and losses are equal to or less than zero percent or are more than ten percent (NO in step S801), the advice generation unit 321 executes the processing of step S803.

(Step S802)

The advice generation unit 321 generates a diagnostic result regarding the user's trading tendency, including the followings:
Information on the user's trading tendency
Information on the reasons for the user's trading tendency
Information on the social aspect of the user's trading tendency
Information to improve the user's trading tendency

(The same shall apply to steps S804, S806, S808, and S809).

Regarding the user's trading tendency, the advice generation unit 321 performs comparison and diagnosis, for example, as follows. “It can be said crucial to have a style where funds increase steadily in this low-interest rate era. However, if we wish for more, it is possible to say that there is still room for improvement.”

(Step S803)

The advice generation unit 321 determines whether the trading gains and losses are more than ten percent and equal to or less than twenty percent. When the trading gains and losses are more than ten percent and equal to or less than twenty percent (YES in step S803), the advice generation unit 321 executes the processing of step S804. When the trading gains and losses are equal to or less than ten percent or are more than twenty percent (NO in step S803), the advice generation unit 321 executes the processing of step S805.

(Step S804)

Regarding the user's trading tendency, the advice generation unit 321 performs comparison and diagnosis, for example, as follows. “Your trading is excellent, for the gains are more than ten percent at an annualized rate. However, if we wish for more, the relevant ten-percent range is calculated by incorporating the compound-interest effect; therefore, you can gear yourself up toward the next level. As for improvement points, it is essential to check the other indexes to improve the weaknesses. If the winning gain rate is poor, you need to improve it; if the turnover rate is poor, you should speed up the turnover a little.

(Step S805)

The advice generation unit 321 determines whether the trading gains and losses are more than twenty percent. When the trading gains and losses are more than twenty percent (YES in step S805), the advice generation unit 321 executes the processing of step S806. When the trading gains and losses are not more than twenty percent, that is to say, are equal to or less than twenty percent (NO in step S805), the advice generation unit 321 executes the processing of step S807.

(Step S806)

Regarding the user's trading tendency, the advice generation unit 321 performs comparison and diagnosis, for example, as follows. “The principal has increased more than 20 percent per year; therefore, asset building is sufficiently successful. Improving the poor indexes and boosting further the good indexes can gear you up toward even higher levels. You deal with trading stocks quite effectively; if the held stocks also have many valuation gains, we can indeed say it is ideal.”

(Step S807)

The advice generation unit 321 determines whether the trading gains and losses are more than minus ten percent and equal to or less than zero percent. When the trading gains and losses are more than minus ten percent and equal to or less than zero percent (YES in step S807), the advice generation unit 321 executes the processing of step S808. When the trading gains and losses are equal to or less than minus ten percent (NO in step S807), the advice generation unit 321 executes the processing of step S809.

(Step S808)

Regarding the user's trading tendency, the advice generation unit 321 performs comparison and diagnosis, for example, as follows. “Your trading lingers in negative territory. Earnest trading does not generate good results but uninteresting results. It would be even more so if the held stocks have problems. It is essential to look in the first place for improvement points, where you should try to improve. The trading pattern analysis can present to you whether the trading or the selection of stocks has problems. Finding out the more common trading patterns allows you to understand whether trading or stock selection has more problems. If the trading is problematic, calculate the ‘winning gain rate+losing loss rate.’ If the ‘winning gain rate+losing loss rate’ is close to or below zero, it is essential to improve this value (making the positive value larger) by taking profits slowly and cutting losses fast. Then, raise the winning percentage to go up toward positive territory. You should take action following the advice.”

(Step S809)

Regarding the user's trading tendency, the advice generation unit 321 performs comparison and diagnosis, for example, as follows. “Decreasing more than 10 percent per year, the assets are shrinking. Unless the status of the held stocks is outstanding, we can say that your trading has much room for improvement and needs to be corrected at various points. From where should you work on correction? The starting point is the trading pattern analysis. It is essential to understand which patterns are common in your trading. If the selection of stocks is problematic, it is crucial to change this point in the first place. You should trade strategic stocks. If trading is problematic, problems such as late loss cut, too early profit-taking, poor winning percentage, too slow turnover, and the like are conceivable. Check your performance on each evaluation axis and correct it beginning from where there is much room for improvement. We think that by following the advice more than before, it is likely to be improved.”

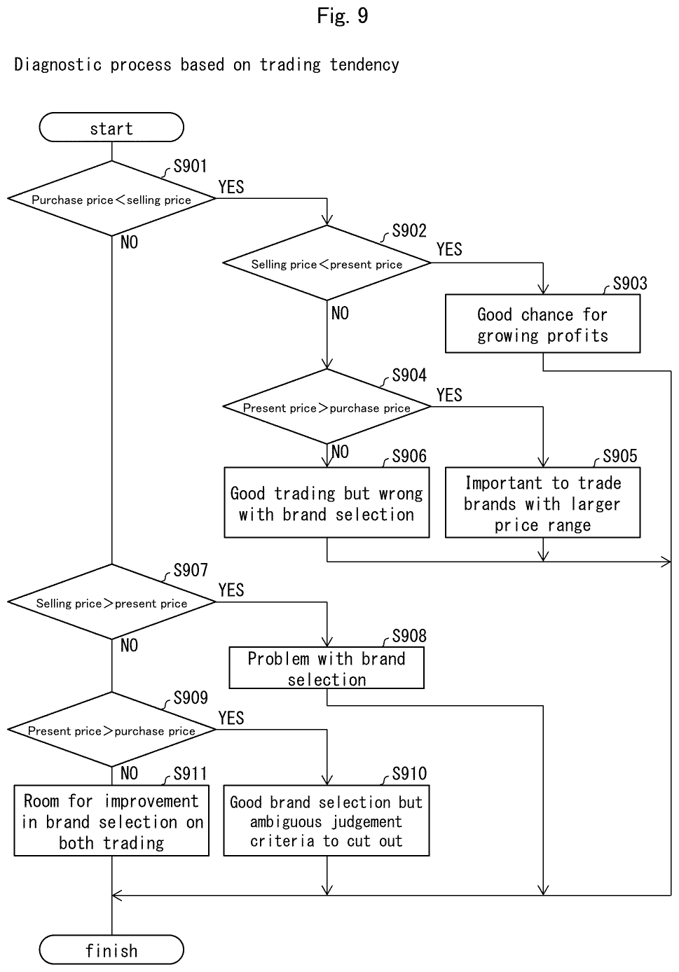

FIG. 9 is a flowchart showing the classification processing of trading patterns of the advice generation unit 321 in the server 3 with regard to the present embodiment. In the following processing, the determining method is described using the current price; however, without limiting to the current price, it may be determined using the market prices after the sale (including the market price at the time three months after the sale and the current price).

(Step S901)

The advice generation unit 321 determines whether the purchase price is lower than the selling price. When the purchase price is lower than the selling price (YES in step S901), it executes the processing of step S902. When the purchase price is not lower than the selling price, that is to say, the purchase price is equal to or higher than the selling price (NO in step S901), it executes the processing of step S907.

(Step S902)

The advice generation unit 321 determines whether the selling price is lower than the current price. When the selling price is lower than the current price (YES in step S902), it executes the processing of step S903. When the selling price is not lower than the current price, that is to say, the selling price is equal to or higher than the current price (NO in step S902), it executes the processing of step S904.

(Step S903)

The advice generation unit 321 generates a diagnostic result regarding the user's trading tendency, including the followings:
Information on the user's trading tendency
Information on the reasons for the user's trading tendency
Information on the social aspect of the user's trading tendency
Information to improve the user's trading tendency
(The same shall apply to steps S905, S906, S908, S810, and S911).

Regarding the user's trading tendency (winning pattern 1: [purchase price<selling price<current price]), the advice generation unit 321 performs comparison and diagnosis, for example, as follows. “A user with a high percentage of this trading pattern may well be able to increase the gains further. The selection of stocks is not wrong; you need to see whether you can secure a more extensive price spread or whether your profit-taking is too early. In the cases of too late profit-taking, you may be missing out on other opportunities; the turnover perspective is also essential.”

Further, the advice generation unit 321 generates advice responding to winning pattern 1 as follows. “Moving forward, you can improve it further depending on how skillful you can trade from the stock selection stage and how you replace stocks.”

(Step S904)

The advice generation unit 321 determines whether the current price is higher than the purchase price. When the current price is higher than the purchase price (YES in step S904), it executes the processing of step S905. When the current price is not higher than the purchase price, that is to say, the current price is equal to or lower than the purchase price (NO in step S904), it executes the processing of step S906.

(Step S905)

Regarding the user's trading tendency (winning pattern 2: [purchase price<selling price; selling price>=current price; current price>purchase price]), the advice generation unit 321 performs comparison and diagnosis, for example, as follows. “A user with a high percentage of this trading pattern selects stocks and trades skillfully. However, if we wish for more, it is essential to trade those stocks that offer opportunities for a more extensive price spread. This is particularly true in the case where the winning gain rate is low. Trading stocks without opportunities for an extensive price spread prevents the winning gain rate from going up.”

Further, the advice generation unit 321 generates advice responding to winning pattern 2 as follows. “Switching to the trading of strategic stocks will bring improvement. In this case, it means improving the winning gain rate, an index of most importance.”

(Step S906)

Regarding the user's trading tendency (winning pattern 3: [purchase price<selling price; selling price>=current price; current price<=purchase price]), the advice generation unit 321 performs comparison and diagnosis, for example, as follows. “A user with a high percentage of this trading pattern makes mistakes in stock selection in the first place. You purchased stocks that you should not have purchased at that time, and you could win, only because you sold them quickly. Thus, the trading was successful, but the selection of stocks was wrong. If the percentage of this kind of trading is high, you are likely to be fascinated by sharply fluctuating stocks at the moment, such as incentive-backed stocks and speculative stocks. This indicates that you get involved mainly in those stocks that are not gainful without trading, conversely, those stocks that generate losses when continuing holding. Therefore, you are forced to trade them.”

Further, the advice generation unit 321 generates advice responding to winning pattern 3 as follows. “It is essential to select safe stocks to hold whose prices will rise instead of those unsafe to hold. This will generate more leeway in your trading.”

(Step S907)

The advice generation unit 321 determines whether the selling price is higher than the current price. When the selling price is higher than the current price (YES in step S907), it executes the processing of step S908. When the selling price is not higher than the current price, that is to say, the selling price is equal to or lower than the current price (NO in step S907), it executes the processing of step S909.

(Step S908)

Regarding the user's trading tendency (losing pattern 1: [purchase price>=selling price>current price]), the advice generation unit 321 performs comparison and diagnosis, for example, as follows. “A user with a high percentage of this trading pattern has problems with the selection of stocks. Getting involved mainly in popular stocks at the moment or getting involved in those stocks with fresh news or speculative stocks will create a losing streak like this. These stocks essentially refer to those stocks you should not hold, as well as those stocks generating huge losses unless sold.”

Further, the advice generation unit 321 generates advice responding to losing pattern 1 as follows. “If the percentages of losing pattern 1 and winning pattern 3 are high, you need to change stock selection considerably. Change your style from that seeking an opportunity to make trading gains to an investment style. Since you are likely a skillful trader, your performance can improve dramatically if you become able to select stocks appropriately. To begin with, you should trade strategic stocks.”

(Step S909)

The advice generation unit 321 determines whether the current price is higher than the purchase price. When the current price is higher than the purchase price (YES in step S909), it executes the processing of step S910. When the current price is not higher than the purchase price, that is to say, the current price is equal to or lower than the purchase price (NO in step S909), it executes the processing of step S911.

(Step S910)

Regarding the user's trading tendency (losing pattern 2: [purchase price>=selling price; selling price<=current price; current price>purchase price]), the advice generation unit 321 performs comparison and diagnosis, for example, as follows. “A user with a high percentage of this trading pattern selects stocks well but cuts losses too early or has ambiguous judgment criteria for loss cut. Combining it with other indexes is needed. A high percentage of winning pattern 1 indicates prime excellence in stock selection.”

Further, the advice generation unit 321 generates advice responding to losing pattern 2 as follows. “The more skillful trading is, the more the assets increase. The important indexes are the winning gain rate, the losing loss rate, their difference, and the like.”

(Step S911)

Regarding the user's trading tendency (losing pattern 3: [purchase price>=current price>=selling price]), the advice generation unit 321 performs comparison and diagnosis, for example, as follows. “A user with a high percentage of this trading pattern has room for improvement in both stock selection and trading. However, in this trading pattern, the losses are controlled small; if wins are extensive, it can be an ideal manner of winning.”

Further, the advice generation unit 321 generates advice responding to losing pattern 3 as follows. “If you lose significantly, it is vital to correct the mistakes in stock selection.”

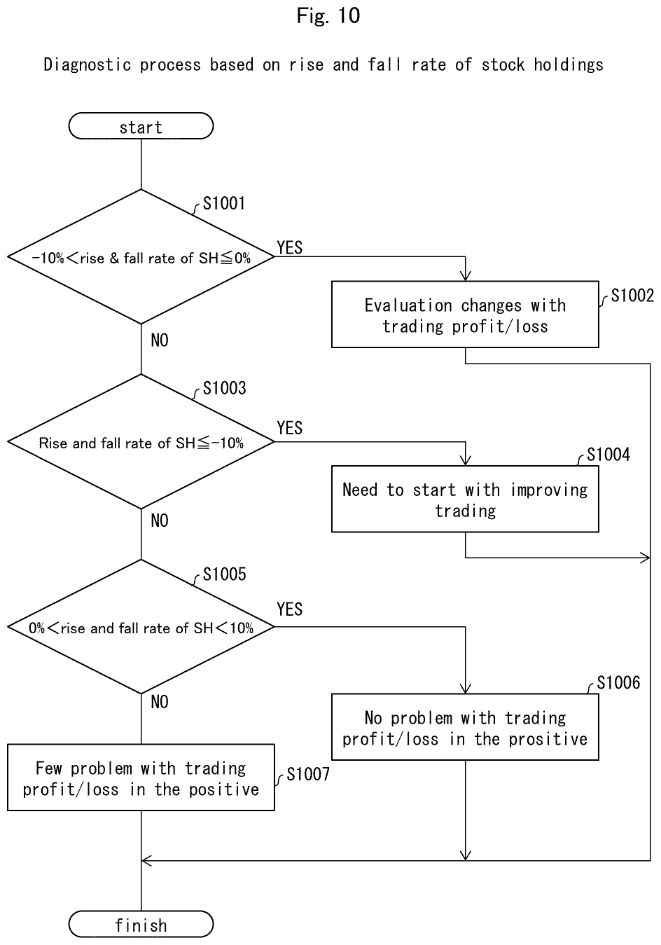

FIG. 10 is a flowchart showing the diagnostic processing based on the rise/fall rate of held stocks (hereinafter briefly referred to as the “rise/fall rate”) of the advice generation unit 321 in the server 3 with regard to the present embodiment.

The advice generation unit 321 classifies the trading data into held-stock data and already-traded data, then calculates the rise/fall rate of the held stocks by referencing such held-stock data. Next, the advice generation unit 321 executes the following diagnostic processing.

(Step S1001)

The advice generation unit 321 determines whether the rise/fall rate is more than minus ten percent and equal to or less than zero percent. When the rise/fall rate is more than minus ten percent and equal to or less than zero percent (YES in step S1001), the advice generation unit 321 executes the processing of step S1002. When the rise/fall rate is equal to or less than minus ten percent or is more than zero percent (NO in step S1001), the advice generation unit 321 executes the processing of step S1003.

(Step S1002)

The advice generation unit 321 generates a diagnostic and comparative result regarding the user's trading tendency, including the followings:
Information on the user's trading tendency
Information on the reasons for the user's trading tendency
Information on the social aspect of the user's trading tendency
Information to improve the user's trading tendency
(The same shall apply to steps S1004, S1006, and S1007).

Regarding the user's trading tendency, the advice generation unit 321 performs comparison and diagnosis, for example, as follows. “Some stocks generate gains, and some generate losses. Additionally, the valuation varies greatly depending on the trading gains and losses. If the trading gains and losses are extensively positive, it seems there are few problems. If the trading gains and losses are little or negative, it seems there is much room for improvement. It is essential for you to analyze trading gains and losses along with the six-trading-pattern analysis and the like to recognize your trading patterns. The improvement of trading and stock selection should also improve the held stocks. We think there is a way to go; however, it indicates much room for improvement and many factors to be altered.”

(Step S1003)

The advice generation unit 321 determines whether the rise/fall rate is equal to or less than minus ten percent. When the rise/fall rate is equal to or less than minus ten percent (YES in step S1003), the advice generation unit 321 executes the processing of step S1004. When the rise/fall rate is not equal to or less than minus ten percent (NO in step S1003), the advice generation unit 321 executes the processing of step S1005.

(Step S1004)

Regarding the user's trading tendency, the advice generation unit 321 performs comparison and diagnosis, for example, as follows. “Stocks left in mothballs are found. There seems much room for improvement unless the trading gains and losses are considerably good. You need to check the comprehensive judgment, or the like, to begin with the improvement of trading. This is because it is likely that those stocks unable to trade nor cut losses remained to be these held stocks. In the world of stock, it is crucial to cut losses of failed stocks earlier. Do not drag your feet for good. Easy to say, however, loss cut is indeed challenging. If you are bad at it, to get things started, try to imitate the support content. This is because a loss cut opens up a new possibility of stock trading in one go. It is essential to dispose of the held stocks even at a gradual pace and make the state with unrealized gains.”

(Step S1005)

The advice generation unit 321 determines whether the rise/fall rate is more than zero percent and less than ten percent. When the rise/fall rate is more than zero percent and less than ten percent (YES in step S1005), the advice generation unit 321 executes the processing of step S1006. When the rise/fall rate is equal to or more than ten percent (NO in step S1005), the advice generation unit 321 executes the processing of step S1007.

(Step S1006)

Regarding the user's trading tendency, the advice generation unit 321 performs comparison and diagnosis, for example, as follows. “If there are no problems in trading gains and losses, it appears progressing favorably. However, it is essential to check them along with the trading pattern analysis. If the percentages of winning patterns 2 and 3 are high rather than that of winning pattern 1 in the classification processing of trading patterns, you need to review the selection of stocks. This is because you are likely to purchase stocks without opportunities for an extensive price spread. You should leverage strategic stocks more that offer opportunities for a more extensive price spread.”

(Step S1007)

Regarding the user's trading tendency, the advice generation unit 321 performs comparison and diagnosis, for example, as follows. “If the trading gains and losses are also positive, it appears there are few problems. However, you need to check them along with other evaluation axes such as turnover force, winning gain rate, losing loss rate, and winning percentage. Improve the weaknesses.”

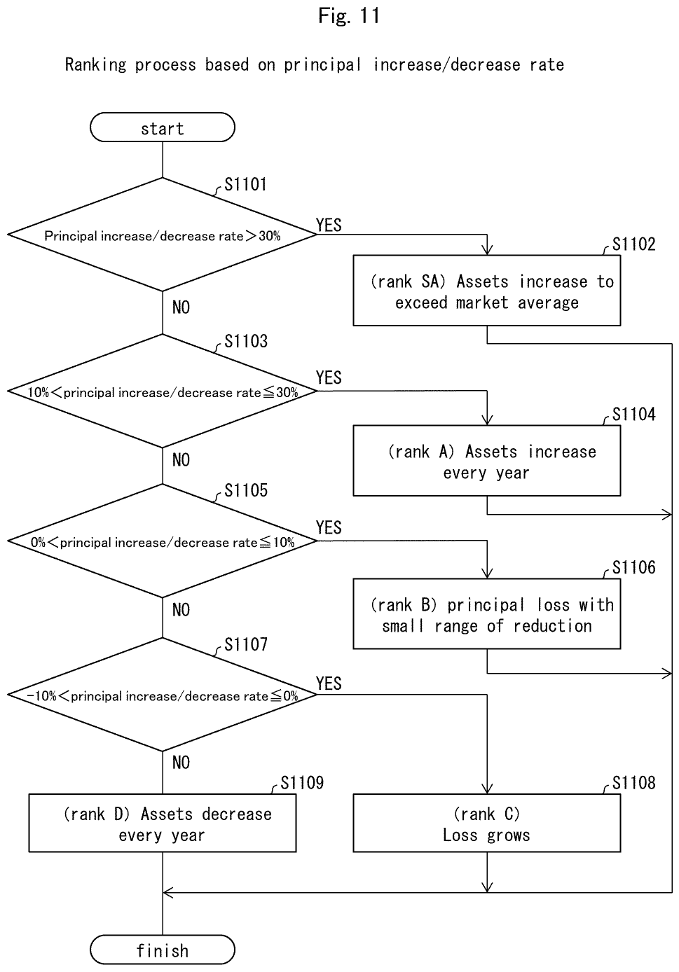

FIG. 11 is a flowchart showing the ranking processing based on the principal increase/decrease rate of the advice generation unit 321 in the server 3 with regard to the present embodiment. The advice generation unit 321 may perform comparison processing and ranking processing using an evaluation index other than the principal increase/decrease rate and perform comparison processing and ranking processing using a plurality of evaluation indexes.

(Step S1101)

The advice generation unit 321 determines whether the principal increase/decrease rate is more than thirty percent. When the principal increase/decrease rate is more than thirty percent (YES in step S1101), the advice generation unit 321 executes the processing of step S1102. When the principal increase/decrease rate is not more than thirty percent (NO in step S1101), the advice generation unit 321 executes the processing of step S1103.

(Step S1102)

The advice generation unit 321 generates a diagnostic result regarding the user's trading tendency, including the followings:
Information on the user's trading tendency
Information to improve the user's trading tendency

(The same shall apply to steps S1104, S1106, S1108, and S1109).

Regarding the user's trading tendency (special A-rank), the advice generation unit 321 performs comparison and diagnosis, for example, as follows. “The assets are increasing at a pace higher than the market average, indicating it is ideal. It depends on whether the trading gains and losses or the valuation gains have contributed more. If the trading gains and losses have contributed more, the turnover will also become appropriately effective.”

Further, the advice generation unit 321 generates advice responding to special A-rank as follows. “By improving the weakness on each evaluation axis, it is likely the gaining power and the asset-growth pace will increase further.”

(Step S1103)

The advice generation unit 321 determines whether the principal increase/decrease rate is more than ten percent and equal to or less than thirty percent. When the principal increase/decrease rate is more than ten percent and equal to or less than thirty percent (YES in step S1103), the advice generation unit 321 executes the processing of step S1104. When the principal increase/decrease rate is equal to or less than ten percent (NO in step S1103), the advice generation unit 321 executes the processing of step S1105.

(Step S1104)

Regarding the user's trading tendency (A-rank), the advice generation unit 321 performs comparison and diagnosis, for example, as follows. “Although it is not so much at an annualized rate, the funds are increasing year by year. Your operation is something like gains breeding gains. It is not even from year to year; however, the pace is above the average.”

Further, the advice generation unit 321 generates advice responding to A-rank as follows. “By checking the indexes that are meaningful to compare with Nikkei Stock Average, compare your increasing rates with the market average. If it underperforms the market, there is much more room for improvement. If it overperforms the market, you should recognize the weaknesses and improve them.”

(Step S1105) The advice generation unit 321 determines whether the principal increase/decrease rate is more than zero percent and equal to or less than ten percent. When the principal increase/decrease rate is more than zero percent and equal to or less than ten percent (YES in step S1105), the advice generation unit 321 executes the processing of step S1106. When the principal increase/decrease rate is equal to or less than zero percent (NO in step S1105), the advice generation unit 321 executes the processing of step S1107.

(Step S1106)

Regarding the user's trading tendency (B-rank), the advice generation unit 321 performs comparison and diagnosis, for example, as follows. “The decline is slight, but it falls below the principal amount; there is various room for improvement. Start with checking whether the held stocks generate losses, then whether the held stocks generate losses, according to this order.”

Further, the advice generation unit 321 generates advice responding to B-rank as follows. “If the held stocks generate losses, the first point to be corrected is your incapability of cutting losses. Another point is whether the initial selection of the stocks to purchase is appropriate or not.”

(Step S1107)

The advice generation unit 321 determines whether the principal increase/decrease rate is more than minus ten percent and equal to or less than zero percent. When the principal increase/decrease rate is more than minus ten percent and equal to or less than zero percent (YES in step S1107), the advice generation unit 321 executes the processing of step S1108. When the principal increase/decrease rate is equal to or less than minus ten percent (NO in step S1107), the advice generation unit 321 executes the processing of step S1109.

(Step S1108)

Regarding the user's trading tendency (C-rank), the advice generation unit 321 performs comparison and diagnosis, for example, as follows. “The losses are bulging; we recommend immediate improvement. First of all, grasp the problems. If the held stocks generate losses, check whether the already-traded stocks generate losses. If the already-traded stocks have generated losses, you should further refer to the winning percentage, the losing loss rate, the trading pattern analysis, and the like.”

Further, the advice generation unit 321 generates advice responding to C-rank as follows. “You should start improving from the particular weaknesses. Please refer to the advice on how to improve them, beginning from inferior evaluation axes.”

(Step S1109)

Regarding the user's trading tendency (D-rank), the advice generation unit 321 performs comparison and diagnosis, for example, as follows. “The assets are decreasing year by year. It is essential to recognize the problems first; whether the trading gains and losses or the rise/fall rate of held stocks has problems.”

Further, the advice generation unit 321 generates advice responding to D-rank as follows. “The incapability of cutting losses has enlarged the unrealized losses of the held stocks. Alternatively, too fast turnover has created a situation with no asset growth whatsoever considering busy working. Which is closer to your trading state? If the former is closer, the losing loss rate and the six-trading-pattern analysis are of importance. If the latter is closer, the winning gain rate, the comprehensive loss analysis, and the turnover indexes are of importance.”

(Resolvent Formula of Trading Gains and Losses)

The resolvent formula of the trading gains and losses is shown below:

Trading gains and losses=winning percentage×trading prices in winning×winning gain rate/number of wins×principal×(elapsed days÷turnover period in days of principal)/trading price per trade+(1−winning percentage)×trading prices in losing×losing loss rate/number of losses×principal×(elapsed days÷turnover period in days of principal)/trading price per trade

The resolvent formula of the trading gains and losses, including numerical examples when the principal is 5 million yen, is shown below. Numerical examples are shown in brackets of [ ].

Trading gains and losses=winning percentage [0.33]×trading prices in winning [29.70 million yen]×winning gain rate [0.41]/number of wins×principal [5 million yen]×(elapsed days [1,224]÷turnover period in days of principal [53])/trading price per trade [0.67 million yen]+(1−winning percentage)×trading prices in losing [77.73 million yen]×losing loss rate [−0.08]/number of losses×principal [5 million yen]×(elapsed days [1,224]÷turnover period in days of principal [53])/trading price per trade [0.67 million yen].

As a diagnostic result regarding the user's trading data, the advice generation unit 321 of the server 3 generates a resolvent formula of the trading gains and losses, including numerical values. Additionally, the advice generation unit 321 generates advice referring to the evaluation indexes, including at least the winning percentage, the winning gain rate, the losing loss rate, and the turnover period (in days) of the principal, which are included in the resolvent formula.

[Examples of Advice]

Examples of the advice with regard to the present embodiment are shown below. The advice generation unit 321 of the server 3 generates each piece of advice. The control unit 22 of the terminal 2 lets the display unit 23 display each piece of advice. The contents of the advice shown below are mere examples and do not limit the present invention.

(Advice Example 1)

“The turnover period of the principal is three days; you are good at trading with an extremely high turnover rate. The principal of 1 million yen, turning over 100 times a year, makes the trading prices 100 million yen. Since the turnover is too fast, the gain rate per trade is inevitably low.

In particular, the winning gain rate of 5 percent might be too low.

The winning percentage is 60 percent, the winning gain rate is 5 percent, and the losing loss rate is minus 8 percent. Although the winning percentage is high, the loss amount in losing is large, and loss cut tends to be delayed, indicating that improving the losing loss rate is also urgent.”

(Advice Example 2) “You are likely not to prefer trading. During the past year, you continued holding the stocks after the purchase and did not trade them. You have ample funds; we think you take a stance of purchasing good stocks to continue holding.

Out of the principal of 10 million yen, the trading prices are 5 million yen, and the cash remains at 5 million yen. The winning percentage of the held stocks is 80 percent, and the gain rate in winning is 1.2 times, figures sufficiently high. Your investment stance appears to carefully select and purchase good stocks little by little at the right timing. Additionally, the loss rate of losing stocks is controlled low at around minus 10 percent. It is a stance of carefully selecting and investing in stocks, which only those with financial strength can take.

However, various great opportunities can be found in the stock market. No trading or no replacing stocks means you are likely to miss those opportunities. If you increase the trading prices, you can get monetizing opportunities equivalent to many times the principal amount. With a principal of 10 million yen, by replacing stocks once every three months, monetizing opportunities will dramatically expand. Replacing once a week makes you too busy; however, it does not require much effort if once every three months or so. Refreshing once every three months makes it easier to incorporate those stocks suiting the trend, allowing you to respond to changes flexibly and adaptably.

Since the world of stocks is constantly changing, one can say trading or stock replacement responding to changes are imperative even for those with ample funds. However, the stocks to purchase are different on each occasion, and responding to changes is not easy. Our trading support helps you in those regards.”

(Advice Example 3)

“The turnover period of the principal is one year. To be more precise, out of the principal of 1 million yen, you purchased stocks only once a year, then continued holding them without trading. The trading prices are 1 million yen. The number of trades is zero; however, the winning percentage of the held stocks is 20 percent, and the losing loss rate is minus 30 percent. You are stuck with the unrealized losses. You have left the purchased stocks unattended; the lack of earlier loss cut has deepened the wounds.

We recommend you start mobilizing even a part of those held stocks to trade them as a first step. As the mobilized funds are revitalized to generate gains, you will be motivated to revitalize other stocks left in mothballs, which gradually leads toward improvement. As the crucial point on mobilization, you should keep in mind to cut losses earlier and take profits slowly. Since loss cut seems challenging until you get used to it, we recommend you follow the trading support strictly.”

(Advice Example 4)

“The turnover period of the principal is two months, and the turnover is moderately effective. The principal of 1 million yen, turning over six times a year, makes the trading prices 6 million yen. The winning percentage is 40 percent, the winning gain rate is 40 percent, and the losing gain rate is minus 8 percent.

Although the winning percentage is low, the winning gain rate is very high at 1.4 times, and oppositely, the loss cut in losing is controlled at minus 8 percent. So the assets are increasing steadily, indicating ideal trading. As to turnover frequency, you are replacing stocks once every two months; therefore, no busy working.

The holding period in winning exceeds three months on average, and oppositely, the trading period in losing is two weeks. Thus you have realized, ‘Wins should be extensive and slowly, losses should be small and be withdrawn quickly,’ resulting in trading for asset building.”

(Advice Example 5) “The turnover period of the principal is one month, and the turnover is moderately effective. The principal of 1 million yen, turning over twelve times a year, makes the trading prices 12 million yen. The winning percentage is 70 percent, the winning gain rate is 5 percent, and the losing loss rate is minus 15 percent. You are focusing on the winning percentage, and the winning percentage is high. However, the winning gain rate is too low, and the losing loss rate is too high, resulting in asset decrease. Additionally, the holding period in winning is too short, with the tendency of quick profit-taking; and oppositely, you tend to prolong the holding period of those stocks having generated losses, resulting in loss bulging.

Loss cut tends to be delayed, indicating that improving the losing loss rate is urgent.”

[Specific Examples of Basic Numerical Values (Basic Data) and Evaluation Indexes]

The advice generation unit 321 calculates evaluation indexes from basic numerical values. The calculation of evaluation indexes varies according to the levels (of detail) of gains and losses. Since the evaluation indexes vary, evaluation is performed level by level accordingly. Comparison, diagnosis, and advice can also be performed level by level. Specific examples are shown below regarding the difference in the evaluation indexes according to the levels. The followings are specific examples and do not limit the present invention.

(Specific Example Regarding Evaluation of Total Gains and Losses)

The advice generation unit 321 calculates the principal increase/decrease rate as “principal increase/decrease rate=total gains and losses÷principal” to evaluate the total gains and losses.

The basic numerical values include:
Principal
Total gains and losses
Purchase price
Selling price
Number of purchases
Current valuation amount
Elapsed days
Average holding period in days
The rise/fall rate of benchmarks (such as Nikkei Stock Average) during the elapsed period, and the like.

The evaluation indexes include turnover force indexes and comprehensive indexes.

The turnover force indexes include:
Turnovers (=purchase prices÷principal)
Turnover period in days (=elapsed days÷turnovers)
Average holding period in days and the like.

The comprehensive indexes include:
Principal gain-and-loss rate (=total gains and losses÷principal)
Average purchase price
Average gain-and-loss amount (=total gains and losses÷number of purchases)
Principal gain-and-loss rate (=purchase price÷principal×total gains and losses÷number of purchases÷purchase price÷number of purchases)
Principal gain-and-loss rate (=turnovers×gains and losses per trade÷purchase price per trade)
Comparison with Nikkei Stock Average, cash ratio, investment ratio, current investment amount and the like.

(Specific Example Regarding Evaluation of Total Trading Gains and Losses)

The advice generation unit 321 calculates the principal increase/decrease rate as “principal increase/decrease rate=(total trading gains and losses+total unrealized gains and losses)÷principal” to evaluate the total trading gains and losses.

The basic numerical values include:
Principal
Total trading gains and losses
Purchase price
Number of wins
Total gains in winning
Total purchase prices in winning
Total selling prices in winning
Number of losses
Total purchase prices in losing
Total selling prices in losing
Total losses in losing
Number of trades
Selling price
Elapsed days
Average trading period
and the like.

The evaluation indexes include:
Turnover force
Turnovers of trading stocks (=purchase prices÷principal)
The turnover period in days of trading stocks (=elapsed days÷turnovers)
Average holding period in days of trading stocks
Principal gain-and-loss rate (=total trading gains and losses÷principal)
The winning percentage of trading stocks (=number of wins÷number of trades)
The winning gains per trade of trading stocks (=gains in winning÷number of wins)
The gain rate in winning of trading stocks (=gains in winning÷trading prices in winning)
The losing losses per trade of trading stocks (=losses in losing÷number of losses)
The loss rate in losing of trading stocks (=losses in losing÷trading prices in losing) and the like.

For example, the trading gains and losses can be resolved into the following factors. This resolution allows you to grasp the character of trading.

Total trading gains and losses=winning percentage (33%)×trading prices in winning (29.70 million yen)×gain rate in winning (0.41)÷number of wins+(1−winning percentage)×trading prices in losing (77.73 million yen)×gain rate in losing (−0.08)÷number of losses×principal (5 million yen)×(elapsed days (1,224)÷turnover period in days of principal (53))÷trading price per trade (0.67 million yen).

The trading gains and losses are determined by the turnover force, the gain rate in winning, the loss rate in losing, the principal, the winning percentage, and the like. Resolving into factors allows an evaluation of which factors are strong or weak, making trading tendency evident.

For example, the unrealized gains and losses can be resolved into the following factors.

Unrealized gains and losses=winning percentage (33%)×trading prices in winning (29.70 million yen)×gain rate in winning (0.41)÷number of wins+(1−winning percentage)×trading prices in losing (77.73 million yen)×gain rate in losing (−0.08)÷number of losses×principal (5 million yen)×(elapsed days (1,224)÷turnover period in days of principal (53))÷trading price per trade (0.67 million yen).

Concerning evaluating the unrealized gains and losses, the turnover force, the gain rate in winning, the loss rate in losing, the principal, the winning percentage, and the like are also essential.

(Specific Example Regarding Evaluation of Total Winning Gains)

The advice generation unit 321 calculates the principal increase/decrease rate as “principal increase/decrease rate=(total winning gains+total losing losses+total unrealized gains and losses)÷principal” to evaluate the total winning gains.

The basic numerical values include:
Principal
Total gains
Purchase price
Selling price
Elapsed days
Average trading period in days
and the like.

The evaluation indexes include:
Turnover force
Turnovers (=purchase prices÷principal)
Turnover period in days (=elapsed days÷turnovers)
Average holding period in days
Gain rate in winning (=total gains in winning÷purchase prices in winning)
Winning percentage (=number of wins÷number of trades)
Winning gains per trade (=gains in winning÷number of wins)
The gain rate in winning (=gains in winning÷trading prices in winning)
Total gain amount in winning
Winning purchase price per trade (=purchase price in winning÷number of wins) and the like.

For example, the winning gains can be resolved into the following factors.

Winning gains=(winning percentage (33%)×trading prices in winning (29.70 million yen)×gain rate in winning (0.41)÷number of wins)×(principal (5 million yen)×(elapsed days (1,224)÷turnover period in days of principal (53))÷trading price per trade (0.67 million yen)).

Winning gains=(winning percentage (=number of wins÷number of trades) (33%)×trading prices in winning (29.70 million yen)×gain rate in winning (=(gains in winning pattern 1+gains in winning pattern 2+gains in winning pattern 3)÷trading prices (0.41))÷number of wins)×(principal (5 million yen)×(elapsed days (1,224)÷turnover period in days of principal (53))÷trading price per trade (0.67 million yen)).

Winning gains=gains in winning pattern 1+gains in winning pattern 2+gains in winning pattern 3.

Winning gains=the gains that would have been achieved in winning pattern 1−the lost gains after the sale in winning pattern 1+the losses that were evaded by the sale in winning pattern 2+the gains that would have been achieved by continued holding in winning pattern 2+(current valuation amount−purchase price) in winning pattern 3−(the losses in the case of continued holding) in winning pattern 3−(current valuation amount−the losses that were evaded by the sale at the selling price) in winning pattern 3.

(Specific Example Regarding Evaluation of Winning Gain Pattern)

The advice generation unit 321 calculates the principal increase/decrease rate as “principal increase/decrease rate=(total unrealized gains and losses+total gains in winning pattern 1+total gains in winning pattern 2+total gains in winning pattern 3+total losses in losing pattern 1+total losses in losing pattern 2+total losses in losing pattern 3)÷principal” to evaluate the total winning gains.

The basic numerical values of winning pattern 1 include:
Principal
Total gains
Purchase price
Selling price
Elapsed days
Average trading period in days
Total gains and losses after the sale
Total gains and losses in the case of continued holding
Total trading gains and losses, and the like.

The evaluation indexes of winning pattern 1 include:
The total gain amount that would have been achieved if not sold during the average holding period
The gain amount that would have been achieved per trade if not sold
The gain amount that would have been achieved if not sold÷gains in winning pattern 1
The total gain amount that would inherently have been achieved
The total gain amount that would inherently have been achieved÷gains in winning pattern 1
Average holding period
The elapsed period if not sold
The holding period if not sold after the purchase
The total gain amount that would inherently have been achieved÷the holding period if not sold after the purchase
The gain amount that would have been achieved if not sold÷the elapsed period if not sold and the like.

For example, the gains in winning pattern 1 can be resolved into the following factors.

Gains in winning pattern 1=percentage of winning pattern 1 (=(number of winning pattern 1÷number of wins)×(number of wins÷number of trades))×trading prices in winning pattern 1 (10 thousand yen)×gain rate in winning pattern 1 (=gains in winning pattern 1÷trading prices in winning pattern 1)÷number of winning pattern 1×principal (5 million yen)×elapsed days (1,224)÷turnover period in days of principal (=(elapsed days÷(trading price÷principal)) (53))÷trading price per trade (0.67 million yen).

Gains in winning pattern 1=the gains that would have been achieved in winning pattern 1−the lost gains after the sale in winning pattern 1.

Gain rate in winning pattern 1=(the gains that would have been achieved in winning pattern 1−the lost gains after the sale in winning pattern 1)÷trading prices in winning pattern 1.

Gains in winning pattern 1=percentage of winning pattern 1 (=number of winning pattern 1÷number of trades)×trading prices in winning pattern 1 (10 thousand yen)×(the gains that would have been achieved in winning pattern 1−the lost gains after the sale in winning pattern 1)÷trading prices in winning pattern 1÷number of winning pattern 1.

(Comprehensive Gains and Losses)

In the server 3, the advice generation unit 321 obtains trading data of investment products, obtains basic numerical values (basic data) from the obtained trading data, calculates evaluation indexes concerning trading gains and losses and unrealized gains and losses from the obtained basic numerical values, obtains evaluation indexes concerning comprehensive gains and losses from the calculated evaluation indexes and generates information indicating the obtained evaluation indexes.

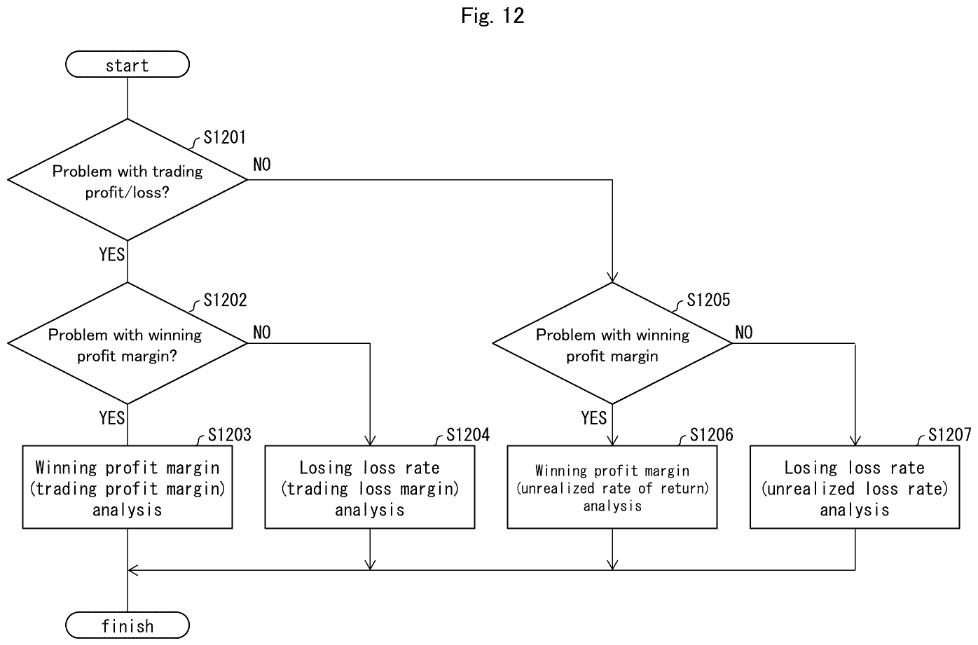

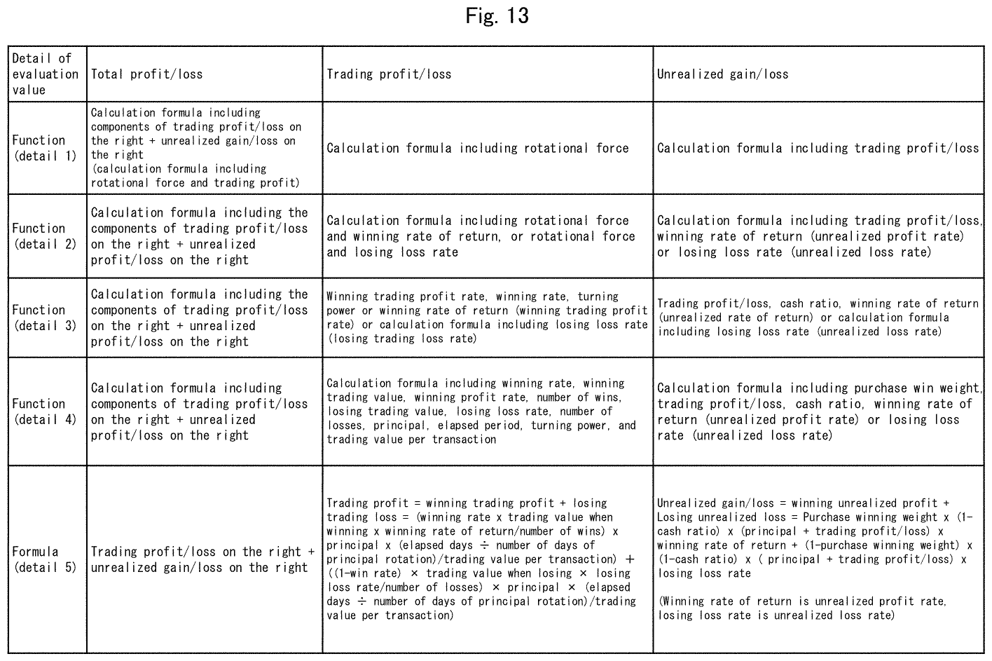

FIG. 12 is a flowchart showing the processing of the comprehensive gain-and-loss analysis with regard to the present embodiment. FIG. 13 is a diagram showing an example of evaluation numerical values of comprehensive gains and losses, trading gains and losses, and unrealized gains and losses according to the levels of detail with regard to the present embodiment.

As shown in FIG. 13, the comprehensive gains and losses are expressed as the sum of the trading gains and losses and the unrealized gains and losses. The unrealized gains and losses use the trading gains and losses as a parameter in the calculation formulae, thus are linked to changes in the trading gains and losses. Accordingly, the unrealized gains and losses are likely to increase as the trading gains and losses increase, raising the possibility that the comprehensive gains and losses will further increase. That is to say, the compound-interest effect of the comprehensive gains and losses through the synergy of the trading gains and losses and the unrealized gains and losses can be expected.

In other words, the comprehensive gains and losses can be said as the total gains and losses, including the unrealized gains and losses generated by investment products, as well as the realized gains and losses.

The evaluation indexes of comprehensive gains and losses include:
Turnover force
Winning gain rate (trading gain rate and unrealized gain rate)
Losing loss rate (trading loss rate and unrealized loss rate)
Cash ratio
Purchase winning weight (the winning percentage of unrealized trading)
Winning percentage (the winning percentage of trading) and the like.

The comprehensive gains and losses are affected by various evaluation indexes depending on the levels of detail of the evaluation numerical values and use various evaluation indexes according to the levels of detail for evaluation. For example, when using the calculation formula for a level of detail of 5, the most fragmented evaluation indexes are used, making more detailed analysis and evaluation possible.

As shown in FIG. 12, in the server 3, the advice generation unit 321 grasps as a diagnostic procedure the broad outlines as to what are good and what are bad by analyzing the comprehensive gains and losses, then delves deeply into those bad areas to clarify the points to improve.

(Step S1201)

The advice generation unit 321 determines whether the trading gains and losses out of the comprehensive gains and losses are problematic. When the trading gains and losses are problematic (YES in step S1201), the advice generation unit 321 executes the determination of step S1202. When the trading gains and losses are not problematic (that is, the unrealized gains and losses are problematic) (No in step S1201), the advice generation unit 321 executes the determination of step S1205.

(Step S1202)

The advice generation unit 321 determines whether the winning gain rate (trading gain rate) is problematic. When the winning gain rate is problematic (YES in step S1202), the advice generation unit 321 executes the processing of step S1203. When the winning gain rate is not problematic (that is, the losing loss rate is problematic) (No in step S1202), the advice generation unit 321 executes the processing of step S1204.

(Step S1203)

The advice generation unit 321 analyzes the winning gain rate (trading gain rate).

(Step S1204)

The advice generation unit 321 analyzes the losing loss rate (trading loss rate).

(Step S1205)

The advice generation unit 321 determines whether the winning gain rate (unrealized gain rate) is problematic. When the winning gain rate is problematic (YES in step S1205), the advice generation unit 321 executes the processing of step S1206. When the winning gain rate is not problematic (that is, the losing loss rate is problematic) (No in step S1205), the advice generation unit 321 executes the processing of step S1207.

(Step S1206)

The advice generation unit 321 analyzes the winning gain rate (unrealized gain rate).

(Step S1207)

The advice generation unit 321 analyzes the losing loss rate (unrealized loss rate).

As a specific example of steps S1205 to S1207, for example, if the absolute value of the winning gain rate (unrealized gain rate) is more than threshold A and the absolute value of the losing loss rate (unrealized loss rate) is less than threshold B (<threshold A), the advice generation unit 321 may generate a diagnosis indicating that the winning gain rate is sufficiently high and the losing loss rate is sufficiently low, as well as advice that recommends the user selling the stocks whose losing loss rate is calculated low to realize loss cut and purchasing investment products that are expected to generate more gains using the funds obtained by the sale. Since the winning gains are significant, it makes sense to realize losses earlier within the gains. However, if the holding period (for example, number of days, number of months, and the like) of those stocks with a low losing loss rate is shorter than a prescribed value, the advice generation unit 321 does not generate the diagnosis and advice. This is because the holding period remains short, with the possibility that the operation has not yet generated meaningful results for the relevant stocks.

In the analysis of steps S1203, S1204, S1206, and S1207, it may be analyzed whether the winning gain rate or the losing gain rate is higher than (outperforms) those indexes to be compared (for example, Nikkei Stock Average).

With this, multifaceted evaluations are possible, such as, for example, “Concerning the diagnosis of comprehensive gains and losses at the start, although the turnover force is high, the winning gain rate is low, and the trading gains are small, resulting in the compound-interest effect not functioning. Additionally, the unrealized losses are extensive; the comprehensive gains and losses also become negative,” or “You have not cut losses and have prolonged the holding period of those stocks having generated losses, resulting in the bulging of unrealized losses. On the other hand, since you sell those stocks quickly that has generated gains, the winning gain rate is low, and the losing loss rate is high (the unrealized losses are large).”

Investment products are products to be invested in, including FX, stocks, investment trusts, ETFs, and the like, and refer to fluctuating-type products whose value fluctuates. However, calculation formulae are not strictly unique; for example, the trading price per trade can be replaced by (the trading prices÷the number of trades).

The unrealized gains and losses are expressed by the functions of, for example, cash ratio, trading gains, winning gain rate (unrealized gain rate), and the like. The comprehensive gains and losses from investment products are the sum of the trading gains and losses and the unrealized gains and losses. Therefore, the comprehensive gains and losses are affected by these evaluation indexes.

(Advantageous Effects of Resolution of Comprehensive Gains and Losses)

By examining, of course, whether the unrealized gains or the finalized gains are generated from investment products (the roughest evaluation method), as well as the effect of the cash ratio on the gains and losses, and the compound-interest effect where gains breed gains, and the like, and additionally, by comprehensively checking the turnover force, the gain rate in winning, the loss rate in losing, and the like, it is possible to identify where many problems reside, comprehensively evaluate the points to be improved with priority, and diagnose.

For example, a case is presented where the trading gains and losses are extensive, the winning gain rate is high, and the losing loss rate is controlled low, but the unrealized losses are bulging hugely. The following can be an example: Since the unrealized losses have big problems to be improved, it is needed to evaluate those points with priority and more details.

For example, a case is presented where the unrealized gains are extensive and carefully selected stocks are purchased at the right timing, with a high winning gain rate (unrealized gain rate); however, various held stocks remain with unrealized losses, and the turnover is not effective at all. In this case, realizing trading gains and losses (loss cut, and the like) to increase the fund efficiency and raise the turnover force is likely to generate better results. Therefore, such necessity is informed.

(Unrealized Gains and Losses)

The unrealized gains and losses refer to gains and losses not yet realized. They are the gains and losses yet-to-realized calculated from the purchase price (in the case of short selling, the selling price; hereinafter, the same shall apply) of a product that has not yet been reversely traded. The unrealized gains and losses usually refer to the difference between the valuation amount of a product calculated by the market price and the purchase price of the product.

(Definition of Terms)

The winning gains refer to unrealized gains that have not yet been realized or finalized.

The winning gain rate is an unrealized gain rate and is calculated as “gains in winning÷purchase prices in winning.” The purchase prices in winning are the purchase prices that constitute the unrealized gains (that is, the purchase prices of the products not reversely traded) out of the purchase prices that constitute the unrealized gains and losses.

The losing losses refer to unrealized losses that have not yet been realized or finalized.

The losing loss rate is an unrealized loss rate and is calculated as “losses in losing÷purchase prices in losing.” The purchase prices in losing are the purchase prices that constitute the unrealized losses out of the purchase prices that constitute the unrealized gains and losses.

The cash ratio refers to the percentage of the amount remaining as cash to the available amount for purchase (principal+trading gains and losses+deposits/withdrawals). Deposits/withdrawals are cash amount that has increased or decreased by depositing or withdrawing since the principal was inputted. “1−cash ratio” indicates the percentage of the holding prices of the products to the available amount for purchase.

The purchase winning weight is the percentage of the purchase prices that constitute the unrealized gains to the relevant purchase prices. Therefore, “1−purchase winning weight” indicates the percentage of the purchase prices that constitute the unrealized losses to the relevant purchase prices.

The unrealized gains and losses comprise cash ratio, trading gains and losses, purchase winning weight, winning gain rate (unrealized gain rate), losing loss rate (unrealized loss rate), and the like, as expressed by the calculation formulae of FIG. 13.

Besides the trading gains and losses described above, the unrealized gains and losses and the comprehensive gains and losses can also be evaluated level by level.

(Specific Example Regarding Evaluation of Total Unrealized Gains and Losses)

The advice generation unit 321 evaluates the total unrealized gains and losses.

The basic numerical values include:
Principal
Total unrealized gains and losses
Purchase prices of unsold stocks (or uncovered stocks)
Current valuation amount of unsold stocks (or uncovered stocks)
Elapsed days
The number of wins of held stocks
Total unrealized gains of held stocks in winning
Purchase prices of held stocks in winning
The number of losses of held stocks
Total losses of held stocks in losing
Trading prices of held stocks in losing
Number of purchases
The number of different held stocks
Average holding period in days
and the like.

The evaluation indexes include:
Turnover force
Principal increase rate (=(purchase prices+cash amount)÷(principal+deposits/withdrawals))
Annual principal increase rate (=principal increase rate÷elapsed years)
Average holding period in days
Gain-and-loss rate (=total unrealized gains and losses÷total purchase prices)
Winning percentage (=number of wins÷number of purchases)
Winning gains per trade (=gains in winning÷number of wins)
The gain rate in winning (=gains in winning÷purchase prices in winning)
Stocks share
Winning stocks share
Losing stocks share
Gains and losses constituent ratio (by stocks)
Average rise/fall rate (at an annualized rate)
Unrealized gain-and-loss weight
Trading gain-and-loss weight
Nikkei Stock Average rise/fall rate
and the like.

(Level of Detail of Evaluation Numerical Value of Unrealized Gains and Losses)

As shown in FIG. 13, the unrealized gains and losses can be evaluated, for example, by five-level evaluation numerical values with different levels of detail.

The function for a level of detail 1 is expressed by a calculation formula containing trading history. More specifically, in the server 3, the advice generation unit 321 may, as the evaluation indexes concerning unrealized gains and losses, calculate evaluation indexes including trading gains and losses from the basic numerical values and generate information indicating the calculated evaluation indexes.

The function for a level of detail 2 is expressed by a calculation formula containing trading gains and winning gain rate (unrealized gain rate) or losing loss rate (unrealized loss rate). More specifically, in the server 3, the advice generation unit 321 may, as the evaluation indexes concerning unrealized gains and losses, calculate evaluation indexes including trading gains and losses and winning gain rate or losing loss rate from the basic numerical values and generate information indicating the calculated evaluation indexes.

The function for a level of detail 3 is expressed by a calculation formula containing trading gains, cash ratio, winning gain rate (unrealized gain rate), or losing loss rate (unrealized loss rate). More specifically, in the server 3, the advice generation unit 321 may, as the evaluation indexes concerning unrealized gains and losses, calculate evaluation indexes including trading gains and losses, winning gain rate or losing loss rate, and cash ratio from the basic numerical values and generate information indicating the calculated evaluation indexes.

The function for a level of detail 4 is expressed by a calculation formula containing purchase winning weight, principal, trading gains and losses, cash ratio, winning gain rate (unrealized gain rate), and losing loss rate (unrealized loss rate). More specifically, in the server 3, the advice generation unit 321 may, as the evaluation indexes concerning unrealized gains and losses, calculate evaluation indexes including trading gains and losses, winning gain rate or losing loss rate, cash ratio, and purchase winning weight from the basic numerical values and generate information indicating the calculated evaluation indexes.

The calculation formula for a level of detail of 5 is as shown below.

Unrealized gains and losses=purchase winning weight×(1−cash ratio)×(principal+trading gains and losses)×winning gain rate+(1−purchase winning weight)×(1−cash ratio)×(principal+trading gains and losses)×losing loss rate.

The calculation formula for a level of detail of 5 if depositing or withdrawing is carried out after principal input is as shown below.

Unrealized gains and losses=purchase winning weight×(1−cash ratio)×(principal+trading gains and losses+deposits/withdrawals)×winning gain rate+(1−purchase winning weight)×(1−cash ratio)×(principal+trading gains and losses+deposits/withdrawals)×losing loss rate.

Provided that the winning gain rate refers to the unrealized gain rate, and the losing loss rate refers to the unrealized loss rate.

More specifically, in the server 3, the advice generation unit 321 may, as the evaluation indexes concerning unrealized gains and losses, calculate evaluation indexes including trading gains and losses, winning gain rate or losing loss rate, cash ratio, purchase winning weight, and principal from the basic numerical values and generate information indicating the calculated evaluation indexes.

Further, after the evaluations according to the levels of detail respectively, a diagnosis regarding which index has big problems is performed, and advice recommending improvement starting with the index with bigger problems is generated. More specifically, in the server 3, the advice generation unit 321 may preferentially generate information indicating lower-evaluated indexes out of a plurality of evaluation indexes concerning unrealized gains and losses.

Further, the advice generation unit 321 may generate information indicating diagnosis, ranking, comparison, or advice, using evaluation indexes concerning the comprehensive gains and losses or the unrealized gains and losses. For example, since calculating evaluation indexes makes various evaluations possible, comparison with other products regarding the evaluation indexes may be performed. Its result may be included in the diagnosis, ranking, comparison, and advice.

(Evaluation, Diagnosis, Advice of Held Products)

In the server 3, the advice generation unit 321 may calculate total purchase prices (purchase prices), product valuation amount, and benchmark valuation amount from the basic numerical values, then compare the total purchase prices, the product valuation amount, and the benchmark valuation amount to generate information indicating a diagnosis or advice concerning asset status according to the comparison result.

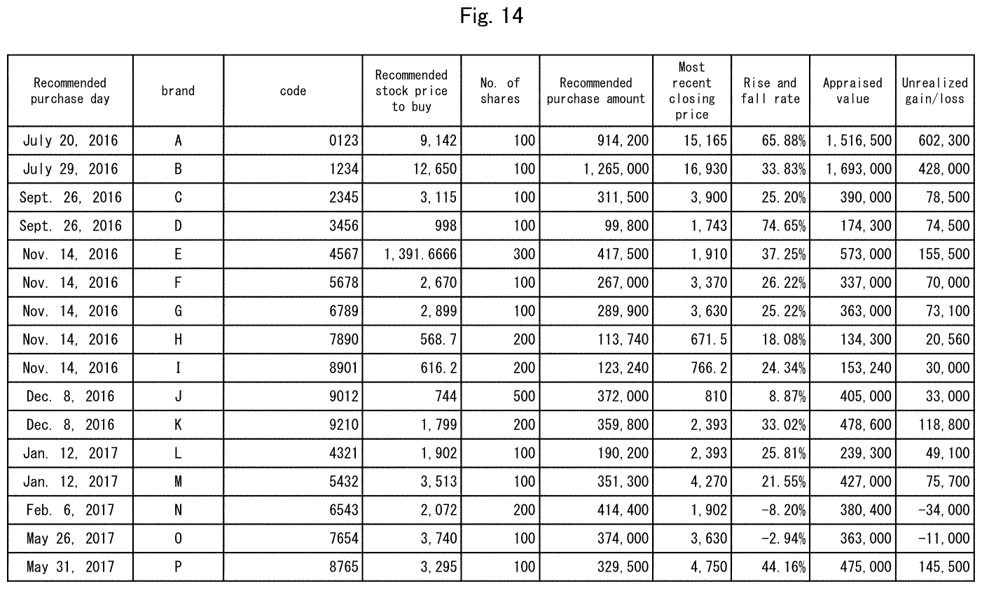

FIG. 14 is a diagram showing an example of evaluation indexes of held products with regard to the present embodiment.

The procedures for the advice generation unit 321 to evaluate the asset status of the user's held products, that is, the products that have not been reversely traded after the purchase (in the case of short selling, after the sale), are shown below. The following procedures can perform a comprehensive evaluation of held products.

(S1) The advice generation unit 321 calculates “purchase price×the rise/fall rate of the relevant product” for each held product. The rise/fall rate of a product refers to the rise/fall rate from the time of purchase to the present. The advice generation unit 321 calculates the rise/fall rate of the product by the following formula 1.

The rise/fall rate of the product=(current valuation amount−purchase price)/purchase price×100 [%]. Formula 1

(S2) The advice generation unit 321 sums up the “purchase price×the rise/fall rate of the relevant product” of each held product. Such total amount is used as the product valuation amount. The product valuation amount indicates the sum of the current valuation amount of each held product.

(S3) The advice generation unit 321 calculates “recommended purchase price×the rise/fall rate of the benchmark” for each held product. The rise/fall rate of the benchmark refers to the rise/fall rate from the purchase recommendation to the present. Benchmarks are not limited to Nikkei Stock Average, TOPIX, or the like. However, they may be a valuation amount generated by dedicated software, the stock price of specific stocks, or the like. The advice generation unit 321 calculates the rise/fall rate of the benchmark by the following formula 1.

The rise/fall rate of the benchmark=(current benchmark amount−the benchmark amount at the time of purchase recommendation)/the benchmark amount at the time of purchase recommendation×100 [%]. Formula 2

(S4) The advice generation unit 321 sums up the “recommended purchase price×the rise/fall rate of the benchmark” of each held product. Such total amount is used as the benchmark valuation amount. The benchmark valuation amount indicates the sum of the current valuation amounts of the relevant held products assuming that those benchmark-linked products were purchased at the relevant prices.

(S5) The advice generation unit 321 compares the total purchase prices, the product valuation amount, and the benchmark valuation amount to generate information indicating a diagnosis or advice concerning asset status according to the comparison result. The total purchase prices indicate the sum of the purchase price of each held product.

With this, for example, when the product valuation amount exceeds the benchmark valuation amount, it is possible to evaluate how much amount is exceeding. When the product valuation amount falls below the benchmark valuation amount, it is possible to evaluate how much amount is falling below. When the benchmark is Nikkei Stock Average, it can be inferred that the operation of Nikkei 225 index-linked products will make better results than the actual investment products. Therefore, a diagnosis that the stock selection is problematic can be performed.

Additionally, even if the benchmark valuation amount exceeds the product valuation amount, there were many products to be invested that have brought higher performance during such period. Therefore, by presenting the performances, tips or advice for better performance can be provided. The following can be an excellent example of tips and advice: For example, if you had held stocks B for the relevant period, your performance could have been three times higher than holding stocks A.

(Pattern Classification of Held Products)

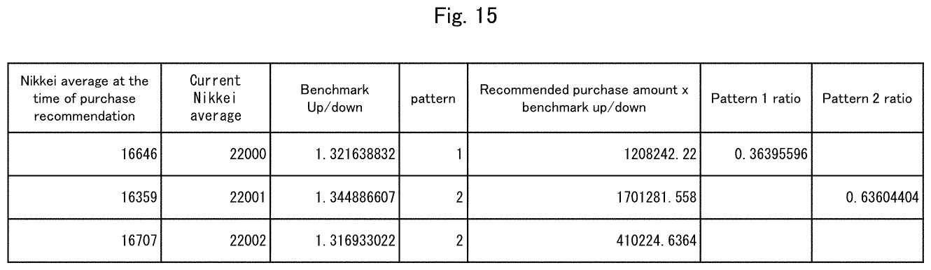

FIG. 15 is a diagram showing an example of patterns of held products with regard to the present embodiment.

In the server 3, the advice generation unit 321 may obtain yet-to-reversed trading data from the trading data, then classify the yet-to-reversed trading data into patterns according to current prices, purchase prices, rise/fall rate of investment products held as well as the rise/fall rate of benchmarks, then calculate a purchase price or product valuation amount for each of such patterns from the yet-to-reversed trading data to generate information indicating a diagnosis or advice concerning asset status according to the ratio of the purchase price or product valuation amount for each of such patterns.

First, the advice generation unit 321 classifies each held product into patterns. The advice generation unit 321 classifies the user's held products into the following four patterns. Namely, winning pattern 1 refers to a pattern where the current price is higher than the purchase price, and the rise/fall rate of the relevant stocks is higher than the rise/fall rate of the benchmark. Winning pattern 2 refers to a pattern where the current price is higher than the purchase price, and the rise/fall rate of the relevant stocks is lower than the rise/fall rate of the benchmark. Losing pattern 1 refers to a pattern where the current price is lower than the purchase price, and the rise/fall rate of the relevant stocks is higher than the rise/fall rate of the benchmark. Losing pattern 2 refers to a pattern where the current price is lower than the purchase price, and the rise/fall rate of the relevant stocks is lower than the rise/fall rate of the benchmark.

Next, the advice generation unit 321 calculates the total purchase prices or the product valuation amount for each of the above four patterns and calculates the ratio of the amount of each pattern to the total amount of the four patterns. Then it generates diagnosis or advice depending on the ratio of each pattern or which pattern has the largest amount.

For example, when winning pattern 1 makes up 70 percent, and winning pattern 2 makes up 30 percent, the advice generation unit 321 generates a diagnosis that “Your performance is above the average, and both the purchased stocks and the timing of purchase are good,” and advice that “See the index regarding how much it exceeds.”

Additionally, when winning pattern 2 makes up 80 percent, winning pattern 1 makes up 10 percent, and losing pattern 1 makes up 10 percent, the advice generation unit 321 generates a diagnosis that “Although gains are generated, your performance falls below the benchmark,” and advice that “There is much room for improvement. We encourage you to gear yourself up toward performance above the average.”

Additionally, when losing pattern 1 makes up 80 percent, the advice generation unit 321 generates a diagnosis that the user is suffering losses as the benchmark falls, such as, “Although losses are generated, this is because the benchmark is falling. Losses are controlled small, considering,” and advice encouraging earlier loss cut, such as “However, the fact that losses are accrued remains unchanged. it is essential to cut losses earlier, and otherwise, to avoid continued holding of the applicable stocks for a long time.”

Additionally, when losing pattern 2 makes up 90 percent, it generates a diagnosis that “The unrealized losses are extensive and holding it back significantly,” and advice that “We recommend you improving both the timing of purchase and the selection of stocks. Loss-cut techniques are also essential. It would help if you mastered early the loss cut in case of failure besides stock selection and the timing of purchase.”

(Advantageous Effects of Evaluating Unrealized Gains and Losses)

The following advantageous effects are achieved by including the trading gains and losses as a constituent of the unrealized gains and losses to make them subject to evaluation.

First of all, the unrealized gains and losses are hugely affected by the already finalized losses and gains (trading gains and losses). If the finalized gains are secured extensively, the purchase prices increase. Accordingly, when the trading gains are extensive, larger gains can be effected with the same gain rate. Conversely, when the trading gains and losses become negative, the purchase prices decrease, ending in smaller gains even with the same gain rate.

(Principal+trading gains and losses)÷principal or (principal+trading gains and losses+deposits/withdrawals)÷(principal+deposits/withdrawals) is an index indicating by how much the principal is increased with trading gains and losses. The purchase prices, which are a certain constituent of the unrealized gains and losses, are expressed as (principal+trading gains and losses−cash balance), and the like; thus, these indexes are the factors that hugely affect the unrealized gains and losses.

The above description clarified the significant influence of the changes in trading gains and losses on the unrealized gains and losses. Thus, the so-called compound-interest effect becomes explicit, allowing its conversion into a numerical form to evaluate and diagnose the investment gains and losses.

Additionally, the purchase winning weight and the cash ratio are important evaluation indexes, and it is essential to raise the purchase winning weight within the held products. As with the trading gains and losses, it is also essential how large the difference between the winning gain rate (unrealized gain rate) and the losing loss rate (unrealized loss rate) will be made. The relevant difference is subject to evaluation as well. These ideas allow multifaceted evaluation and diagnosis, even if the unrealized gains and losses are the same.

Additionally, too high a cash ratio will cause opportunity loss, and the unrealized gains that would inherently have been achieved can be roughly estimated. These are also essential factors to be evaluated. Opportunity loss is calculatable as “cash amount×unrealized loss rate.” Furthermore, the winning gain rate (unrealized gain rate), the losing loss rate (unrealized loss rate), and the difference between them are important factors for managing unrealized gains and losses. Thus, they are subject to evaluation. Huge unrealized losses that exceed the trading losses are also significantly problematic and considered a starting point for improvement.

Multifaceted evaluations are possible; for example, it is essential to master how to raise the winning gain rate and how to lower the losing loss rate (unrealized loss rate).

Diagnosis can be performed based on these evaluation numerical values. Moreover, various comparisons such as comparison with others and comparison with the average become possible. Then, users can be ranked, making ranking feasible. Thus, advice based on evaluation, diagnosis, and comparison ranking becomes possible.

### Embodiment 2

Hereinafter, the embodiment 2 of the present invention will be described. For the convenience of description, the component with the same function as a component described in embodiment 1 is appended with the same numerical reference to avoid repeating the description.

In the present embodiment, besides evaluating actual trading, the user performs virtual trading (simulation) based on past actual stock prices and events, and the advice generation unit 321 of the server 3 evaluates regarding the virtual trading. More specifically, as contrasted with actual trading data, the user makes judgments on trading based on past stock prices and events, in a style of answering questions displayed on the terminal 2. Then, the evaluations of trading and gains and losses by the advice generation unit 321 will fork depending on the user's individual judgments.

Entering into details, the server 3 generates information on virtual trading of investment products in the past. In the server 3, the advice generation unit 321 obtains a start date of virtual trading and initial conditions, including those of assumed holding status of investment products and cash at such start date. Then, the advice generation unit 321 generates using such initial conditions at least two questioning screens consecutively, that include dates of events occurring after the start date as well as questions and options concerning trading of investment products.

Additionally, the questioning screens may further contain the events.

Additionally, the questioning screens may further contain valuation amounts of held assets, including investment products and cash at event dates.

Additionally, the advice generation unit 321 may reckon a valuation amount of each investment product at 100 as the base at the first date of events, then calculate an index of the valuation amount of each investment product at the second and later dates of the events based on said 100.

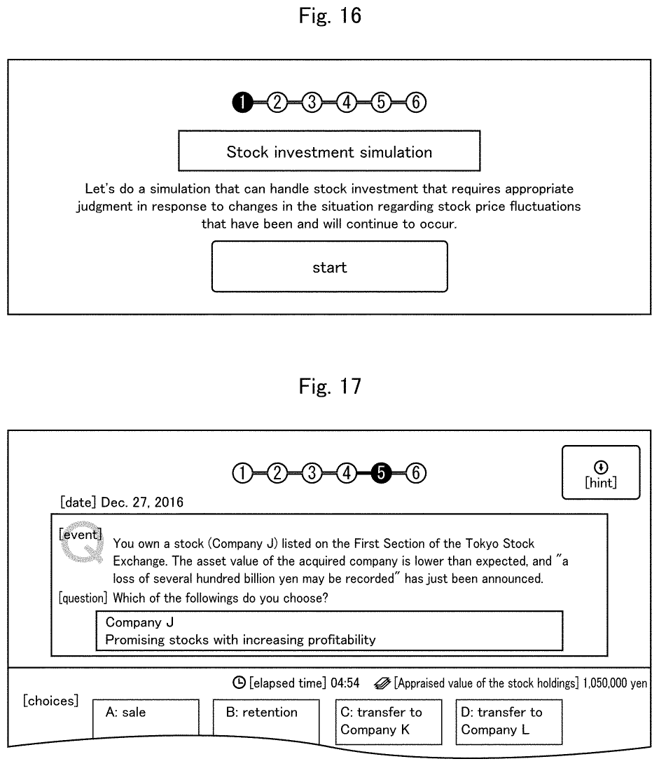

FIG. 16 is a diagram showing an example of the initial screen of the stock investment simulation (virtual trading) with regard to the present embodiment. As shown in FIG. 16, the terminal 2 displays the initial screen of the stock investment simulation. When the user clicks the “Start” button displayed on the initial screen, the terminal 2 starts a stock investment simulation.

FIG. 17 is a diagram showing an example of the questioning screen of the stock investment simulation with regard to the present embodiment. As shown in FIG. 17, the terminal 2 displays the questioning screen of the stock investment simulation. The questioning screen displays events, dates, questions, tips, elapsed period, held assets, and options. The event indicates an incident occurring at that time. The date indicates a date when an event occurred. The question indicates an inquiry to the user. The tip indicates detailed investment advice and the like that differs from events. The elapsed period indicates the time elapsed since the start of a stock investment simulation. The held assets indicate the amount of the assets the user currently holds. Four options are provided in each question. For example, the following four options are listed: A: selling J company stocks; B: continuing the holding of J company stocks; C: switching from J company stocks to K company stocks; D: switching from J company stocks to L company stocks.

Hereinafter, the processes will be described. The processes include the initial conditions, question 1, and result reports.

(Initial Conditions)

The initial conditions include dates, holding status (stock names and numbers of shares, cash amount), and initial valuation amount. The initial valuation amount refers to the valuation amount of all assets, including stocks and cash. The server 3 may hold the default conditions for the initial conditions, or the user may set the initial conditions.

Specific examples of initial conditions are shown below.
Date 0 is defined as the starting point of a stock investment simulation.
The case of four different held stocks (A, B, C, D)
The numbers of shares of stocks A, stocks B, stocks C, and stocks D are a1, b1, c1, and d1, respectively.
Initial valuation amount is a (for example, 4 million yen).

It may be calculated based on the actual number of shares or may be reckoned at 100 at the start of a stock investment simulation as the index of the valuation amount of each stock. The user may start a stock investment simulation from a state holding cash only or holding cash and stocks at a prescribed ratio.

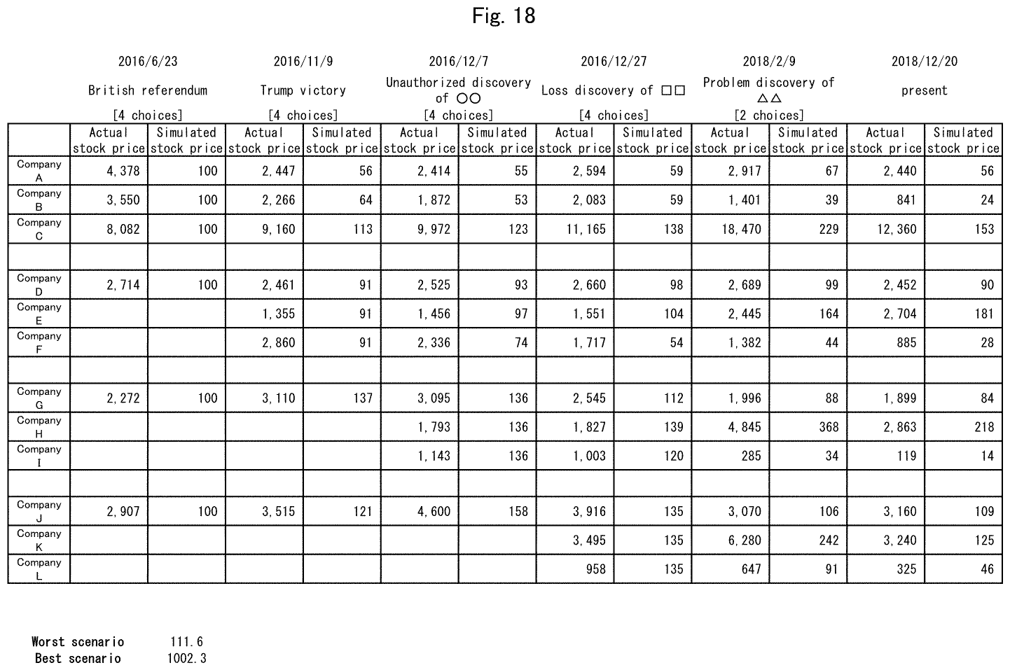

FIG. 18 is a diagram showing an example of the transition of a stock price in the stock investment simulation with regard to the present embodiment. FIG. 18 shows the actual stock price and the simulated stock price on the date of each event. The actual stock price refers literally to the actual price of the stocks. The simulated stock price refers to a stock price expressed as an index. The stock price of each stock on Jun. 23, 2016, is reckoned at 100; thereafter, the stock price of each stock is calculated as an index based on said 100.

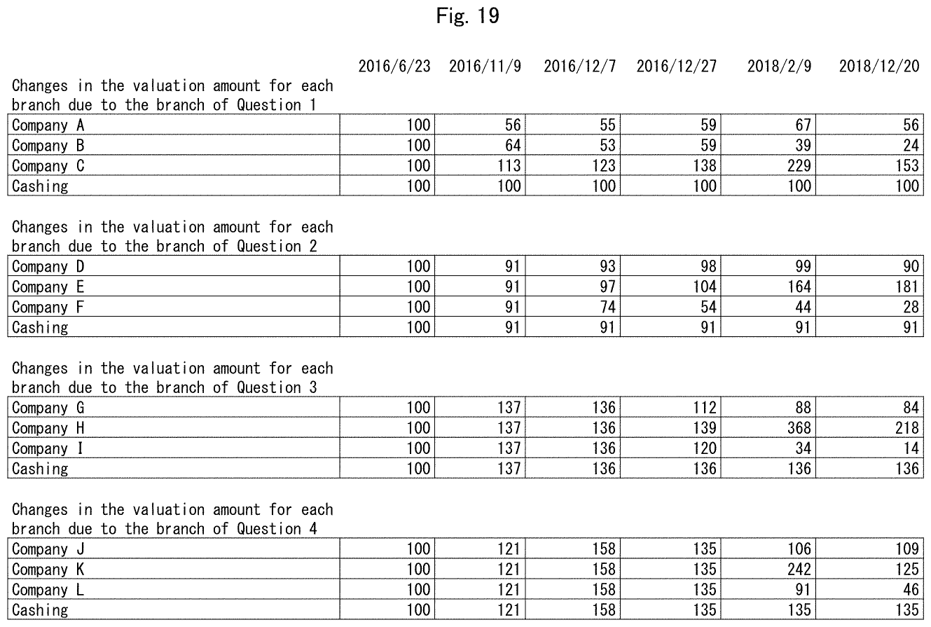

FIG. 19 is a diagram showing an example of the transition of the valuation amount for each fork of each question in the stock investment simulation with regard to the present embodiment. The valuation amount of each stock on Jun. 23, 2016, is reckoned at 100, which is the initial base index. Furthermore, the valuation amount of each stock at the fork of question 2 on Nov. 9, 2016, is set to 91 of index value based on said 100, as a valuation amount of specific stocks. These methods make it easier to evaluate which stocks should have been bought at that time by referencing the subsequent transition of the valuation amount.

For example, if the stocks are switched from G company to E company, cash will be left over in reality. Since this makes the situation complicated, it is assumed that all the sale price was used to switch to the stocks of E company. Thus, on Nov. 9, 2016, the valuation amount of the stocks of E company is 91. If it is assumed that cash is left over in reality, 91 of the valuation amount is broken down into 80 of the stocks of E company and 11 of cash. 91 of valuation amount indicates a case where the cash amount is assumed to be 0; however, it is possible to assume a case where cash is left over to be more realistic.

The above case assumes a situation where all the proceeds from the sale are used to fund the purchase. However, due to the circumstances concerning unit stock, the cases where cash is left over are more realistic. In these cases, the cash balance changes on switching stocks; it is also possible to display such cases.

Hereinafter, each question will be described. The dates for questions (questions 1 to 5) are Jun. 23, 2016; Nov. 9, 2016; Dec. 7, 2016; Dec. 27, 2016; and Feb. 9, 2018, respectively.

(Question 1)
Date 1 (Jun. 23, 2016)
Valuation amount is β (total valuation amount calculated based on each stock price of the stocks A, B, C, and D as of date 1).
The explanation of the status of stocks A and the presentation of options
The explanations of the situation of the entire market and the situation of that day related to the stocks requiring judgment
Options of four cases

In the case of holding stocks: for example, selling stocks A, continuing the holding of stocks A, switching to stocks E, and switching to stocks F. In the case of starting a stock investment simulation with cash only: for example, purchasing stocks A, continuing the holding of cash, purchasing other stocks, and the like.

(Question 2)
Date 2 (Nov. 9, 2016)
Holding
The explanation of the status of stocks B and the presentation of options
Options of four cases (selling stocks B, continuing the holding of stocks B, switching to stocks G, and switching to stocks H)

(Question 3)
Date 3 (Dec. 7, 2016)
The explanation of the status of stocks C and the presentation of options
Options of four cases (selling stocks C, continuing the holding of stocks C, switching to stocks I, and switching to stocks J)

(Question 4)
Date 4 (Dec. 27, 2016)
The explanation of the status of stocks D and the presentation of options
Options of four cases (selling stocks D, continuing the holding of stocks D, switching to stocks K, and switching to stocks L)

(Question 5)
Date 5 (Feb. 9, 2018)
Options of two cases (selling held stocks, the postponement of selling held stocks)

Depending on the answer to questions 1 to 5, 512 (=4×4×4×4×2) valuation amounts are calculated.

Regarding the stock price of each stock as of each date, 1A refers to “the closing price of stocks A as of the date of question 1,” and 2C refers to “the closing price of stocks C as of the date of question 2,” and so on. The stock prices at the start of a stock investment simulation are 0A, 0B, 0C, and 0D.

The advice generation unit 321 calculates the (index-based) valuation amounts of all patterns, assuming that the index at the start of each stock is 100.

First, the advice generation unit 321 calculates the four valuation amounts as of date 1 of question 1 as follows.

(1) In the case of selling stocks A:

The sum of 1A×a1 (cash), 1B×b1, 1C×c1, and 1D×d1. Alternatively, if index-based, the sum of 100×1A/0A, 100×1B/0B, 100×1C/0C, and 100×1D/0D.

(2) In the case of continuing the holding of stocks A:

The sum of 1A×a1 (stocks A), 1B×b1 (stocks B), 1C×cl (stocks C), and 1D×d1 (stocks D).

(3) In the case of switching from stocks A to stocks E:

The sum of 1E×e1, stocks E (the number of shares of stocks E calculated as “1A×a1÷1E”: e1) 1B×b1, 1C×c1, and 1D×d1.

(4) In the case of switching from stocks A to stocks F:

The sum of 1F×f1, stocks F (the number of shares of stocks F calculated as “1A×a1÷1F”: f1) 1B×b1, 1C×c1, and 1D×d1.

Next, the advice generation unit 321 calculates the valuation amount of each case forked at question 1 as of the date of question 2 as follows.

(1) In the case of selling stocks A:

The sum of 1A×a1 (cash), 2B×b1, 2C×c1, and 2D×d1. If index-based, the sum of 100×1A/0A, 100×2B/0B, 100×2C/0C, and 100×2D/0D.

(2) In the case of continuing the holding of stocks A:

The sum of 2A×a1 (stocks A), 2B×b1, 2C×c1, and 2D×d1.

(3) In the case of switching to stocks E:

The sum of 2E×e1,

stocks E (the number of shares of stocks E calculated as “1A×a1÷1E”: e1) 2B×b1, 2C×c1, and 2D×d1.

(4) In the case of switching to stocks F:

The sum of 2F×f1,

stocks F (the number of shares of stocks F calculated as “1A×a1÷1F”: f1) 2B×b1, 2C×c1, and 2D×d1.

Likewise, the advice generation unit 321 calculates the valuation amount for each combination by setting the stock prices of the held stocks or purchased stocks at the stock prices as of the dates of questions 3 and 4. Thus, it is possible to grasp the transition of the valuation amount of the stocks.

For example, in case 3 of question 1, stocks A are switched to stocks E; thus, the valuation amount is transitioned with the stock price of stocks E thereafter. For example, in case 3 of question 2, stocks B are switched to stocks G; thus, the valuation amount is transitioned with the stock price of stocks B at first, but the valuation amount is transitioned with the stock price of stocks E after the switching.

Accordingly, the transition of the valuation amount is formed in four ways at each question. Therefore, depending on the combination of the questions, there arise 512 ways in this case. More specifically, when the user has answered each question, it forks into 512 ways.

The valuation amount transitions in each time series, and the final amount result of the valuation amount also forks into 512 ways.

With the above description, it is possible to calculate the valuation amounts of the four cases of question 1 to grasp their transition. It is possible to calculate the valuation amounts of the four cases of question 2 to grasp their transition. It is possible to calculate the valuation amounts of the four cases of question 1, the valuation amounts of the four cases of question 2, the valuation amounts of the four cases of question 3, and the valuation amounts of the four cases of question 4 using the stock prices at each time point.

### SPECIFIC EXAMPLES

As a specific example, the best scenario is, for example, selecting the third option in every question and selling three different stocks other than those of Recruit in February 2018. The valuation amount is 10.02 million yen.

On the other hand, the worst scenario is, for example, selecting the fourth option in every question. The valuation amount is 1.12 million yen.

In other words, 512 cases stay within such range between 1.12 million yen and 10.20 million yen. Furthermore, the ranking of the final valuation amount can be calculated.

The best scenario is, of course, ranked first. The worst scenario is, of course, ranked 512th.

In the answer, those results are informed as to the rank in the ranking, final valuation amount, the transition of valuation amount, finally-held stocks and cash amount, valuation gains, unrealized gains and losses, trading gains and losses, turnover force, diagnostic result, winning percentage, the gain rate in winning, the loss rate in losing, evaluation numerical values, advice, and the like.

(Modification)

The selection of an option for the date determines the transition of the valuation amount for the relevant question. Therefore, the valuation amount can be tracked in a time series. Initially, it may be started with cash only. For explicit compound-interest effect, the questions may be further forked, for example, as to how to handle further those stocks replaced with at the question. These are merely an example. The number of questions may be small or large.

The more questions are provided, the wider is the difference, the more forks, and the more combinations. The more options are provided in a question, the closer it is to reality and the more combinations.

The judgment of a plurality of different stocks may be incorporated on the same date, and partial sale, or the like, may be incorporated. Short selling and ETFs may also be incorporated.

(Learning Processing)

Depending on the evaluation, the user may be guided to e-learning materials to reinforce weaknesses. For example, in the case of an evaluation that too early profit-taking sales and too high turnover force hinder achieving good trading results, associating teaching materials are looked up in the database to encourage learning through providing links and content, and otherwise.

In the advice presentation system 1, a mechanism is implemented that encourages the user to learn the theories to reinforce weaknesses depending on the evaluation. Through the learning, the user changes practices, leading to the change in trading and evaluation.

E-learning has a mechanism that prevents going forward unless the tests or checking tests are taken. By teaming up with such mechanisms, an operation that encourages reinforcing weaknesses and learning, then trading practically again to achieve good investment results is systemically executed.

With the above description, when the user does not know what to learn or how to improve, it is possible to provide a learning path to the user.

### Advantageous Effects of Embodiment 2

The user can noticeably experience how the result (valuation amount) changes, how the evaluation forks, and how the rank changes depending on individual trading judgment. Further, the user can understand and noticeably experience the process in which personal assets change dynamically, and investment disparities are widened. Namely, it allows the user to realize that the individual trading judgment significantly impacts the investment result.

Thus, it is possible to derive the user's motivation to learn how to operate assets and, further, create learning effects.

### Embodiment 3

Hereinafter, the embodiment 3 of the present invention will be described. For the convenience of description, the component with the same function as a component described in embodiment 1 and 2 is appended with the same numerical reference to avoid repeating the description.

In the present embodiment, the comprehensive diagnosis performed by the advice presentation system 1 will be described.

(Definitions of Comprehensive Gains and Losses and Comprehensive Diagnosis)

The comprehensive gains and losses refer to the gains and losses summing up the unrealized gains and losses and the trading gains and losses. Comprehensive diagnosis refers to a diagnosis that combines individual diagnoses on total gains and losses, unrealized gains and losses, trading gains and losses, and the like.

The advice generation unit 321 performs a comprehensive diagnosis on the user's trading status by combining the individual diagnoses on the total gains and losses, the unrealized gains and losses, and the trading gains and losses.

(Significance of Comprehensive Diagnosis)

In fact, investment results arise from tangling combined factors. A high winning gain rate usually means a low turnover force in winning. Reversely, a low losing loss rate is accompanied by a high turnover force; they are associated. It is essential to diagnose such combined factors comprehensively when examining them in their totality.

For example, the larger are the trading gains, the more they influence the composition of the unrealized gains, making the compound-interest effect clearer. Reversely, with no trading gains, no matter how high the unrealized gains rate is, the funds will increase less than expected. In some cases, even if the winning gain rate is low, the high turnover force can cover it. Each factor influences other factors complicatedly.

For example, if combined conditions that though the winning percentage is low, the winning gain rate is high, and the losing loss rate is low are met, it means the operation is excellent. If the winning percentage is low, the winning gain rate is low, the losing loss rate is low, and the “winning gain rate+losing loss rate” is negative, the operation reduces the assets significantly depending on the figures. Even if other figures are the same, one small figure brings about an utterly different diagnostic result; therefore, the comprehensive diagnosis is quite important.

(Advantageous Effects and Specific Examples of Comprehensive Diagnosis)

Even if the sole results of individual diagnoses do not bring about correct answers, combining the results of a plurality of individual diagnoses to perform a comprehensive diagnosis can attain an appropriate diagnostic result.

For example, if regardless the gains to be ±0 relating to trading gains, the unrealized gains are generated, and the holding periods are elongated in winning, resulting in only good stocks remaining, and losses for poor stocks are cut early, examining only the result of trading gains and losses brings about incorrect diagnosis. Only after making a comprehensive judgment, including the diagnosis of the unrealized gains and losses as well as winning pattern analysis, an appropriate diagnosis comes out. This is a good example.

Even if the turnover force is high, the holding period is short, and the winning gain rate and the losing loss rate are low, some traders make up with the high winning percentage, resulting in good operation. This is a specific example showing that even if individual diagnoses are not so favorable, other outstanding parts can make the comprehensive diagnostic result good.

These specific examples presenting a diagnostic result opposite to individual diagnostic results are a reason for the necessity of a comprehensive diagnosis.

(Process of Comprehensive Diagnosis)

The unrealized gains and the trading gains and losses, which are the comprehensive gains and losses, are formed by tangling various factors. The annual principal increase rate is determined by further complicated combined factors; even if the same results are achieved, types and courses vary. Diagnosis considering combined factors is indispensable for situation analysis. In the process, diagnosis is performed with the combination of various evaluation indexes.

(On Diagnosis by Type)

One method of the comprehensive diagnosis performed by the advice presentation system 1 is the diagnosis by type. In the process of the diagnosis by type, the advice generation unit 321 calculates various evaluation indexes, determines a combination of such evaluation indexes (the ranges of at least two evaluation indexes), then classifies the user's trading status according to the numerical values of such evaluation indexes.

It is possible to classify trading status by pattern according to the combination of various indexes. The patterns as the result of classification are defined as a type.

Types vary. Both broad classification and granular classification are possible. The factors required to determine the type are various evaluation indexes mentioned above, such as the turnover force and the winning gain rate. It is possible to categorize types according to the combinations of various evaluation indexes.

The combination of evaluation indexes allows them to find a type that fits them to a certain degree; thus, various types are determined. Just by changing the boundary values, for example, it may change from type A to type B. Those categories that were so far too general and unclear can now be classified clearly with numerical values, allowing management by type.

(Specific Examples of Type Classification)

The short-term day trading type refers to a type where the turnover force is very high, the turnover period in days of principal ranges from one day to several days, the winning gain rate and the losing loss rate are sufficiently small, and the winning percentage is the decisive factor for gaining power.

The short-term swing trading type refers to a type where the turnover force is high, the turnover period in days of principal is about one week (such as ranging from four days to fourteen days), the winning gain rate and the losing loss rate are small at around five percent, and the winning percentage is again the decisive factor for gaining power.

The extensive price spread-securing type refers to a type where although the turnover force is low, the winning gain rate overwhelmingly exceeds the losing loss rate, resulting in asset increase.

The long-term freeze type refers to a type where the turnover force is low, the average holding period is more than 360 days, the unrealized gains and losses are focused rather than the trading gains and losses, and regarding the breakdown of the unrealized gains and losses, both the winning gain rate (unrealized) and losing loss rate (unrealized) are large, indicating the incapability of sale.

The left-in-mothballs type refers to a type where the turnover force is low, the losing loss rate is high, the winning gain rate is low, and the unrealized losses are generated.

What is essential is that the combinations of evaluation indexes can categorize types, and objective figures can fix the boundaries. They may be derived by combining a plurality of boundary fixes shown in each individual diagnosis.

For example, a case that a certain evaluation numerical value of the turnover force diagnosis is “within three days,” and the weight is high (at least 50 percent) in winning pattern analysis is classified as pattern 1. This pattern is a type where an operation with devoted, effective turnover achieves good results and is regarded as a market-following high turnover type.

Various combinations are possible, and how to make a combination is at liberty, allowing many types to be created. The various evaluation indexes that are the basis of individual diagnoses can solely provide sufficient diagnostic results. However, by utilizing their combination, the advantageous effects that deeper analysis is feasible, and the diagnosis becomes more profound and precise are achieved.

For example, in an individual diagnosis, the turnover force is between seven and thirty days, the winning gain rate exceeds 20 percent, and the losing loss rate is controlled within 10 percent. This type has 200 persons in total. All of them have a high principal increase rate, and 70 percent increase their assets at an annual rate of at least 20 percent. The assets increase annually at 25 percent on average. Such diagnosis and analysis by type can be performed.

(Advantageous Effects of Diagnosis by Type)

The advantageous effects brought about by diagnosis by type include that the user's type is found clearly, comparing with others is easy, and the user will know the existence of various methods. In particular, there is an advantageous effect that the user's position is made clear by the comparison with and ranking within those of the same type, creating a guidepost showing points to be improved.

(Ranking and Comparison by Type)

One method of the comprehensive diagnosis performed by the advice presentation system 1 is the comparison and ranking of evaluation numerical values, such as those of the principal increase/decrease rate, within a type defined by a plurality of factors. The advice generation unit 321 compares and ranks users' such evaluation numerical values for each type categorized according to the numerical values of a plurality of evaluation indexes.

By ranking and comparing the evaluation numerical values for each type, the comparison and ranking of the evaluation numerical values within a group whose members adopt similar methods is possible.

It is possible to learn from others how to advance in a better direction among similar operations. For example, which numerical values are excellent among those who achieve good results in the swing trading type is referenced.

(Advantageous Effects of Ranking and Comparison by Type)

By calculating the evaluation numerical values for each type, the advantageous effect clarifying which type is superior and which type is inferior is expected. With this, for example, the following result can be derived: The principal increase rate (annual rate) of the swing trading type was 10 percent on average. However, the principal increase rate (annual rate) of the extensive price spread-securing type was 25 percent on average, and fewer persons failed.

For example, if regarding the figures of the person with the best result within an above type, the winning percentage is very high, the winning gain rate is high, and the winning pattern 1 accounts for most among winning patterns, the user can compare his/her figures with them to improve the inferior figures. Additionally, the comparison with others, for example, although the user was ranked good among all, they are average figures within the user's type, is made easy, and deeper analysis becomes feasible.

(Examples of Diagnostic Result Report)

Examples of reports of the diagnostic results for the user's trading status are shown below. The phrase “(dynamically changing)” found in the following refers to a text or numerical value, or the like, that dynamically changes depending on the user's trading data.

An example of a report of the comprehensive diagnostic results is shown below. Comprehensive diagnosis:
Diagnosis by Type

The trade type of Mr./Ms. A is determined as swing trading type (dynamically changing).
Description of Type

The swing trading type (dynamically changing) refers to the short-term swing trading type that is a type where the turnover force is high, the turnover period in days of principal is about one week (such as ranging from four days to fourteen days), the winning gain rate and the losing loss rate are small at around five percent, and the winning percentage is again the decisive factor for gaining power.
Your rank in the swing trading type (the principal increase/decrease rate (simple annual interest)) is the 3rd out of 100 persons (dynamically changing).
Type ranking (compared by the average value of the principal increase/decrease rate (simple annual interest))

25th out of 50 types (dynamically changing)
Your rank among all is the 250th out of 1000 persons (dynamically changing).
Combination diagnosis

The calculation formula for the trading gains and the calculation formula for the unrealized gains and losses (dynamically changing)
Comparison with average numerical values (dynamically changing)
Superior numerical values (dynamically changing)
Inferior numerical values (dynamically changing)
Comprehensive diagnostic result (dynamically changing)

You are outstandingly ranked 3rd within the swing trading type. However, you are ranked 250th out of all 1000 persons. Therefore, there seems sufficient room for improvement.

The numerical values of particular superiority are the turnover force and the winning percentage, and inferior numerical values are represented by the low winning gain rate.

An example of a report of the individual diagnostic results is shown below.
Individual diagnosis:
Turnover force diagnosis
Diagnostic result (dynamically changing)
Evaluation numerical value table (dynamically changing)
Description (dynamically changing)
Winning gain rate diagnosis
Losing loss rate diagnosis
Winning pattern analysis
Losing pattern analysis
Trading gain-and-loss analysis
Unrealized gain-and-loss analysis
Comprehensive gain-and-loss analysis

### [Implementing Examples by Software]

The control blocks of the terminal 2 and the server 3 (especially the control unit 22, the control unit 32, and the advice generation unit 321) may be implemented by a logic circuit (hardware) formed into an integrated circuit (IC chip) or the like or may be implemented by software.

In the latter case, the terminal 2 and the server 3 comprise a computer executing the instructions of a program, which is software implementing each function. This computer comprises, for example, at least one processor, as well as a computer-readable recording medium that stores the program. Then, in the computer, the processor reads the program from the recording medium and executes it to achieve the object of the present invention. As the processor, for example, a CPU (Central Processing Unit) can be used. As the recording medium, a “non-transitory tangible medium,” including, for example, besides a ROM (Read Only Memory) or the like, a tape, a disk, a card, a semiconductor memory, a programmable logic circuit, and the like, can be used. Additionally, the computer may further comprise a RAM (Random Access Memory) or the like that loads the program. Furthermore, the program may be supplied to the computer via any transmission medium (including communication network, broadcast wave, and the like) capable of transmitting such program. One aspect of the present invention can also be implemented in the form of a data signal embedded in a carrier wave, which is embodied by the electronic transmission of the program.

The present invention is not limited to each embodiment described above. Various modifications can be made within the scope shown in the claims, and embodiments created by appropriately combining technical means disclosed in different embodiments are also included in the technical scope of the present invention.

### REFERENCE SIGNS LIST

1: Advise presentation system (information presentation system)

2: Terminal (terminal apparatus)

3: Server (information generation apparatus)

4: Network

321: Advice generation unit (information generation unit)

1. An information generation apparatus that generates information on trading of investment products, comprising
an information generation unit configured to:
obtain trading data of investment products;
obtain basic data from the obtained trading data;
calculate evaluation indexes concerning trading gains and losses and unrealized gains and losses from the obtained basic data;
obtain evaluation indexes concerning comprehensive gains and losses from the calculated evaluation indexes; and
generate information indicating the obtained evaluation indexes.

2. The information generation apparatus according to claim 1, wherein said information generation unit calculates, as evaluation indexes concerning the unrealized gains and losses, evaluation indexes including trading gains and losses from the basic data and generates information indicating the calculated evaluation indexes.

3. The information generation apparatus according to claim 1, wherein said information generation unit calculates, as evaluation indexes concerning the unrealized gains and losses, evaluation indexes including trading gains and losses as well as winning gain rate or losing loss rate from the basic data and generates information indicating the calculated evaluation indexes.

4. The information generation apparatus according to claim 1, wherein said information generation unit calculates, as evaluation indexes concerning the unrealized gains and losses, evaluation indexes including trading gains and losses as well as winning gain rate or losing loss rate and cash ratio from the basic data and generates information indicating the calculated evaluation indexes.

5. The information generation apparatus according to claim 1, wherein said information generation unit calculates, as evaluation indexes concerning the unrealized gains and losses, evaluation indexes including trading gains and losses as well as winning gain rate or losing loss rate, cash ratio, and purchase winning weight from the basic data and generates information indicating the calculated evaluation indexes.

6. The information generation apparatus according to claim 1, wherein said information generation unit calculates, as evaluation indexes concerning the unrealized gains and losses, evaluation indexes including trading gains and losses as well as winning gain rate or losing loss rate, cash ratio, purchase winning weight, and principal from the basic data and generates information indicating the calculated evaluation indexes.

7. The information generation apparatus according to claim 3, wherein said information generation unit preferentially generates information indicating lower-evaluated indexes out of a plurality of evaluation indexes concerning the unrealized gains and losses.

8. The information generation apparatus according to claim 1, wherein said information generation unit generates information indicating diagnosis, ranking, comparison, or advice, using evaluation indexes concerning the comprehensive gains and losses or the unrealized gains and losses.

9. The information generation apparatus according to claim 8, wherein said information generation unit calculates purchase prices, product valuation amount, and benchmark valuation amount from the basic data, compares the purchase prices, the product valuation amount, and the benchmark valuation amount, and generates information indicating a diagnosis or advice concerning asset status according to the comparison result.

10. The information generation apparatus according to claim 8, wherein said information generation unit obtains yet-to-reversed trading data from the trading data, classifies the yet-to-reversed trading data into patterns according to current prices, purchase prices, rise/fall rate of investment products held as well as rise/fall rate of benchmarks, calculates a purchase price or product valuation amount for each of such patterns from the yet-to-reversed trading data, and generates information indicating a diagnosis or advice concerning asset status according to the ratio of the purchase price or product valuation amount for each of such patterns.

11. An information generation apparatus that generates information on virtual trading of investment products in the past, comprising
an information generation unit configured to:
obtain a start date of the virtual trading and initial conditions, including those of assumed holding status of the investment products and cash at such start date;
generate using such initial conditions at least two questioning screens consecutively, that include dates of events occurring after the start date as well as questions and options concerning trading of the investment products.

12. The information generation apparatus according to claim 11, wherein said questioning screens further contain the events.

13. The information generation apparatus according to claim 11, wherein said questioning screens further contain valuation amounts of held assets, including the investment products and cash at dates of the events.

14. The information generation apparatus according to claim 11, wherein said information generation unit reckons a valuation amount of each investment product at 100 as the base at the first date of the events, then calculates an index of the valuation amount of each investment product at the second and later dates of the events based on said 100.

15. An information presentation system, comprising:
the information generation apparatus according to claim 1; and
a terminal apparatus,
wherein said terminal apparatus presents information generated by said information generation unit to users.

16. A non-transitory computer-readable storage medium storing an information generation program for causing the information generation apparatus according to claim 1, wherein the information generation program is configured to cause a computer to function as said information generation unit.
